(19) United States
(12) Patent Application Publication
(10) Pub. No.: US 2009/0271863 A1
(43) Pub. Date: Oct. 29, 2009

(54) Identifying unauthorized privilege escalations

(76) Inventors: Sudhakar Govindavajhala, Plainsboro, NJ (US); Andrew W.s Appel, Princeton, NJ (US)

Correspondence Address: Ashok Tankha;Of Counsel, Lipton Weinberger & Husick, 36 Greenleigh Drive, Sewell, NJ, 08080, US

(21) Appl. No.: 11/699,607

(22) Filed: Jan. 30, 2007

Related U.S. Application Data
(60) Provisional application No. 60/763,341, filed on Jan. 30, 2006.

(51) Int. Cl. G06F 21/00

(52) U.S. Cl. 726/23; 726/25; 726/22

(57) ABSTRACT

Disclosed herein is a method and system of determining and/or managing potential privilege escalation attacks in a system or network comprising one or more potentially heterogeneous hosts. The step of configuration scanning optionally includes making a list of operating system specific protection mechanism on each host. Vulnerability scanning optionally includes the step of identifying the vulnerability position of each identified program. Transitive closure of all security attacks on the network and potential privilege escalations can be determined. A user interface optionally renders the potential privilege escalations as an appropriate representation. The method may include none or one or more of several pre-emptive mechanisms and reactive mechanisms. Further, the method may optionally include a mechanism for a periodic safety check on the system ensuring continued security on the network.

### CROSS-REFERENCE TO RELATED APPLICATIONS

This application claims the benefit of U.S. provisional application No. 60/763,341, filed Jan. 30, 2006, titled “Multihost, multistage, vulnerability analysis—MulVal”.

### STATEMENT REGARDING FEDERALLY SPONSORED RESEARCH OR DEVELOPMENT

This invention is funded in part by the Advanced Research and Development Agency, grant # NBCHC030106, and the Defense Advanced Research Projects Agency, grant no. F30602-99-1-0519.

### BACKGROUND

This invention in general relates to security management over a network and specifically relates to a method and system for determining privilege escalations over a network of hosts.

The security of a network depends on two orthogonal elements: individual program security and host and network configuration. Significant advances have been made in the art and science of writing secure programs. A very secure program can be designed and implemented, but the program can still be vulnerable to an attack if the file system or other permissions allow an unauthorized user to overwrite the secure program. The unauthorized user can replace the secure program with an arbitrary code of their choice. There are host wide configuration elements such as group memberships, firewall rules, networked file system configurations, etc., which can affect the security of programs in a network. At installation time, programs modify configuration elements that affect the security of all users and programs of the host. In particular, an installation program might open an attack path through a previously installed program.

To increase the level of security, memberships of groups have to be carefully controlled. Adding an unauthorized user to a trusted group can result in a security breach. However, it is difficult to identify the authorized groups on a host.

When a new vulnerability advisory is reported, it is quite likely that the advisory could affect the security of the network. The system administrator has to identify if the bug is relevant to their network. The system administrator has to identify the machines that are using the affected software and the individual installations affected and determine if an adversary can exploit the bug. An adversary cannot exploit the bug if the affected module is disabled or is hidden behind a firewall. If the adversary can exploit a bug, the administrator will have to determine the network-level consequences. The administrator then has to determine the best or most appropriate remediation measures. Program vulnerability management is thwarted by complex semantics for components, a large number of bug advisories, and limited response time

Current state of the art scanners recognize already existing vulnerabilities on a network of analogous operating systems but do not recognize the privilege escalation path in the network. A vulnerability definition is required to recognize the existence of vulnerability. Current state of the art scanners do not recognize the existence of an unknown bug.

Configuration bugs often cause security vulnerabilities. There are many structural causes for the mistakes made by programmers or administrators in software configuration. A large enterprise network is typically managed by multiple system administrators, wherein each administrator is responsible for specific functionality and where there is a limited overlap between the operational domains of different administrators. Interactions between administrators may be limited by various barriers such as different business processes, different administrative domains, different operating systems and technologies. The result is that each administrator configures the network independently. The global security behavior may in fact be dependent on the configurations of multiple hosts, as well as the dependencies between these hosts. Operation of a network depends on the interactions of configurations across multiple boundaries, but network operators typically do not have access to configurations across boundaries. Policies configured in one part of a network can conflict with the remaining part of the network. Worse, the inconsistencies may result in security holes. It is complex to debug these configuration problems. Professional system administrators and software developers are guided in their tasks by the behavior of the software system as documented by the software vendor. Often the vendors' documentation is obscure and sometimes even incorrect or defective. Software developers often do not understand operating-system security semantics and often cannot predict how these will interact with customers' security configurations. To ensure that their programs always work, they tend to ask for too many privileges. System administrators are therefore compelled to permit excessive privileged access to users. With this excessive grant of privileges, it is inevitable that security bugs will arise.

In FIG. 1, as is currently represented by the known art, the privilege escalations in a network of Red Hat Linux 9.0 hosts are represented as an attack trace, where each step in the attack is shown sequentially. As the possibility of privilege escalation paths increase, the number of attack traces will increase exponential. The limitations of this system are that it confines itself to a network of Red Hat Linux systems 9.0 only, and that the attack traces are very difficult to read by an administrator. Because of the exponential number of traces in prior art, the systems are very slow and the output is very difficult for the administrator to comprehend.

Currently, the system administrators find the task of obtaining network and/or host configuration information such as obtaining a list of authorized users who have access to one or more of the files, services and registry keys, very difficult to perform.

Currently, system administrators, security experts, or bug experts find it a challenge to determine the global effects of a potential configuration change. The configuration issues present the adversary with a very useful avenue to attack the enterprise networks.

Therefore, there is a need for a method to formalize network security analysis, and perform a largely automated security analysis of configuration and program vulnerabilities of a large network with minimal human intervention.

### BRIEF DESCRIPTION OF THE DRAWINGS

The foregoing summary, as well as the following detailed description of the embodiments, is better understood when read in conjunction with the appended drawings. For the purpose of illustrating the invention, there is shown in the drawings exemplary methods and systems of the invention; however, the invention is not limited to the specific methods and instrumentalities disclosed herein.

FIG. 1 exemplarily illustrates a sample attack tree showing a multi-stage attack on the network

FIG. 2 illustrates the network complexity in an exemplary network having multiple hosts with multiple operating systems (OS).

FIG. 3 illustrates the elements required for a secure network.

FIG. 4 illustrates the method of determining potential privilege escalation attacks in a network comprising a central server and a multiplicity of hosts.

FIG. 5 illustrates a system for determining potential privilege escalation attacks in a network.

FIG. 6 exemplarily illustrates the working of a multi host multi stage vulnerability analyzer.

FIG. 7 exemplarily illustrates the privilege escalations found in a default configuration of an operating system.

FIG. 8 exemplarily illustrates a network topology exemplarily considered for network security analysis.

FIG. 9 illustrates an exemplarily vulnerability analysis algorithm.

### DETAILED DESCRIPTION OF THE DRAWINGS

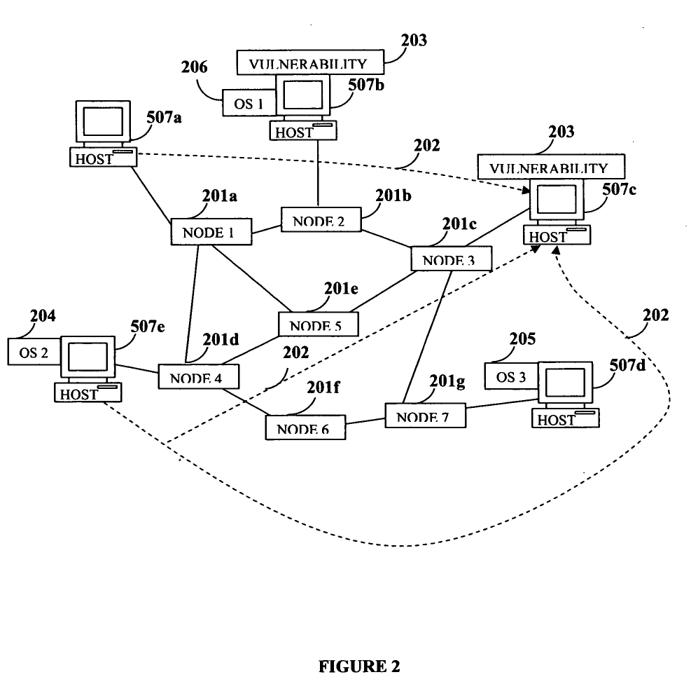

FIG. 2 illustrates the network complexity in an exemplary network having multiple hosts 507a, 507b, 507c, 507d and 507e with multiple operating systems (OS) 204, 205, and 206. The nodes 201a, 201b, 201c, 201d, 201e, 201f, and 201g represent intermediate communications points, where the nodes may be computers, personal digital assistants and other various network appliances such as routers, firewalls, wireless access points, switches and hubs. On a large network, where the number of configuration elements and their interactions between various elements is large, managing the security is a complex and difficult task. System administrators are forced to securely configure hosts running different operating systems to inter-operate. These operating systems have different semantics and one needs to be careful to ensure that the differing semantics are mapped properly.

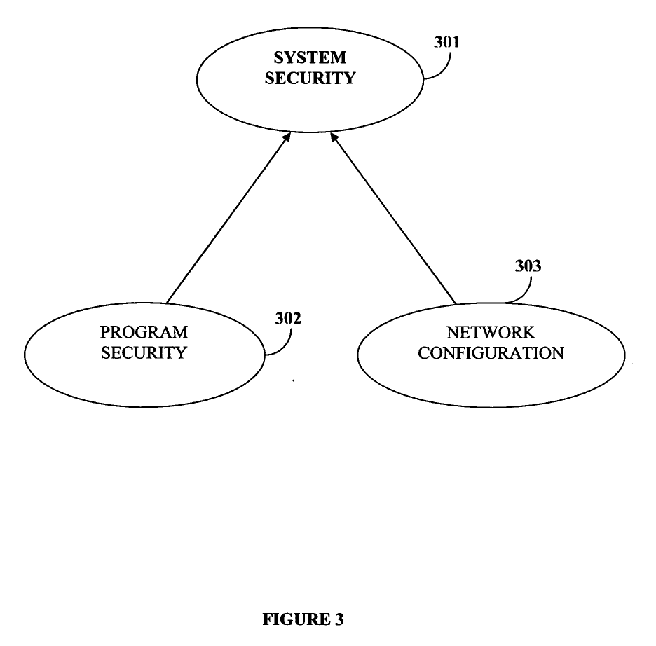

FIG. 3 illustrates the elements required for a secure network. System security 301 depends on program security 302 and network configuration 303. Herein, security vulnerabilities are classified into two classes: program vulnerabilities and configuration vulnerabilities. Program vulnerabilities are security problems caused in a single program by poor software engineering. Configuration vulnerabilities are security holes caused by configuration issues such as firewall rules, file system permissions, group assignment, etc. At installation time, programs modify configuration elements that affect the security of all users and programs of the host. In particular, an installation program might open an attack path through a previously installed program. Methods to improve individual program security include using safe programming languages, reducing trusted computing bases, using sound cryptographic primitives, and ensuring length-checked input fields.

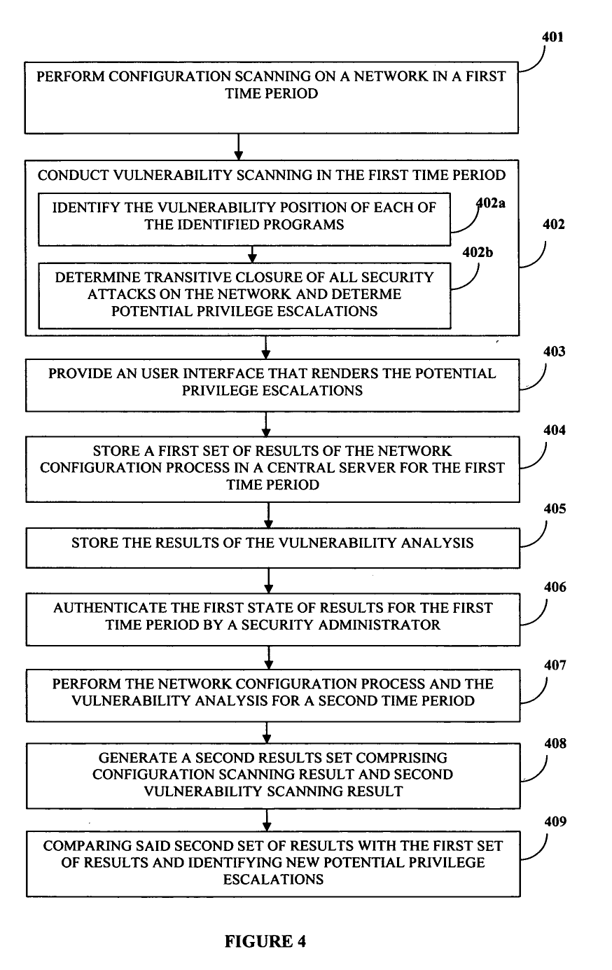

FIG. 4 illustrates the method of determining potential privilege escalation attacks in a network 203 comprising a central server and a multiplicity of hosts in the domain of an administrator. The step of configuration scanning on network 203 in a first time period 101 includes for each host, making a list of files, services and registry keys and other hardware and software resources and their meta data such as security descriptors that define the protection on these objects, WMI keys, processes, network sockets, interprocess communication channels such as shared memory, named pipes, message queues, semaphores, waitable timers, mailslots, network ports, service programs, other hardware or operating system resources and their meta data. A list of authorized users who have access to one or more of the files, services and registry keys, WM keys, processes, network sockets, interprocess communication channels such as shared memory, named pipes, message queues, semaphores, waitable timers, mailslots, network ports, operating system and program services are obtained. Authorized users are classified in groups. All programs that automatically accept input from network 203 are identified. For example, when a user starts computer programs like SMTP server and IIS server (Windows) and Apache HTTP server (Unix) open network connections that wait for other machines to send network packets or other information to the user. Programs like Yahoo messenger, mail reading programs like Outlook automatically connect to central servers to automatically retrieve data over the network. In either case, if these programs have known vulnerabilities, adversaries can exploit these programs by sending malicious information to them.

The method and system disclosed herein of determining privilege escalation of a network of hosts where different hosts run different operating systems include, but not limited to, Windows XP, Windows 2000, Windows NT, Windows Vista, HP-UX, IBM AIX, Unix, Linux such as Red Hat, Debian, Fedora, etc., Solaris, etc. The hosts may run different software, inclusive of any of database servers, mail servers. The networks may contain other networking components such as switches, routers, and firewalls.

Vulnerability scanning in a first time period 402 includes identifying the vulnerability position of each of the identified programs 402a, where the identified program is in the vulnerable position if an unauthorized user can escalate his privileges using the program. Transitive closure of all security attacks on the network 503 and potential privilege escalations 402b are determined. A user interface renders the potential privilege escalations as a pictographic representation 403. A first set of results of the network 503 configuration process is stored in a central server for a first time period, the first set of results including the listing of files, services, registry keys, authorized users, groups and programs and other software and hardware information, and the results of the vulnerability analysis comprising the vulnerability position, potential privilege escalations, and the rendered user interface 404. The results of the vulnerability analysis are stored 405. The first state of results for the first time period is authenticated by the security administrator 406. The network configuration process and the vulnerability analysis for a second time period is performed 407 to generate a second result set. The second result set comprises configuration scanning result and second vulnerability scanning result 408. The second set of results is compared with the first set of results and new potential privilege escalations are identified, wherein these new potential privilege escalations potentially compromise security 409. Both the first set and second set of privilege escalations are useful in identifying how the network can be attacked in the each state. In some scenarios, the cyber security manager may be interested in running the analysis just once to determine privilege escalations.

The first set of results is obtained by applying the system to the results of configuration and vulnerability scanning at a first point in time. These results identify how the network can be attacked at the first point in time. This information is useful in understanding the network security situation in the network at a given point in time. Similarly, the second set of results (obtained by applying the system to the results of the configuration and vulnerability scanning) identifying privilege escalations at the second point in time. Running only one of these two steps is useful in understanding the situation at a single point of time. Running the analysis at multiple times and being able to compare the results allows the user of our system to identify how security of the network is evolving over time.

Compute all the privilege escalations at time T1 to get a result set R1

Compute all the privilege escalations at time T2 to get a result set R2.

For each escalation element E in T1, if it is not is in T2
Print the escalation element E vanished

For each escalation element E in T2, if it is not is in T1
Print the escalation element E is a new escalation

A timing module identifies to the time periods at which the configuration scanning, vulnerability scanning and the analysis are performed to identify escalations. One use case may be to run to the analysis early in the morning before the administrator comes to office so that his task items are defined by the time he starts to work. A cyber security manager uses the timing module to schedule periodically the configuration scanning, vulnerability scanning and privilege escalation analysis system (every day or week or four hours or once a vulnerability advisory is released on vulnerability mailing lists). A user of a MMVA or a program can run MMVA whenever an advisory is reported or a new software program has been installed or asynchronously or on other events. The results are stored to an electronic medium to maintain a historical database to see how privilege escalations are evolving.

If the adversary has the ability to send network input to a program identified vulnerable by vulnerability scanner, then the adversary can get hold of the user account of the program by sending an appropriate attack string as input. After getting hold of the user account running the program, the adversary can launch further attacks. This is expressed as “adversary Alice can get hold of account Bob”.

After obtaining control of Bob's account, Alice can pretend to be Bob and launch further attacks. We now compute what further attacks are possible from Bob. If Bob can launch further attacks and get hold of account Charlie, then adversary Alice can get hold of Charlie's account. Security attacks have a transitive relationship. The MMVA computes this transitive relationship. If A can attack B, and B can attack C, then A can attack C indirectly. In practice this chain of attacks can be long. The transitive closure of attacks is computed as follows:

For each principal A, B, and C in the network:

If A can attack B,

If B can attack C then

A can attack C

Thus, computing the transitive closure of attacks occurs in cubic time. The transitive closure of attacks is performed for a plurality of operating systems including Windows XP, Windows NT, Windows Vista, Windows 2000, UNIX, Solaris, Red Hat Linux, Debian Linux, etc. Further, A can attack B in multiple steps, where each step gives incrementally more level of access to A.

Sometimes it is possible that an attack path actually uses multiple program vulnerabilities. Multiple vulnerabilities can be exploited in tandem to achieve a level of access that is not possible with just a single vulnerability. For example, principal A can send input to a vulnerable program running under account B on the same or different host. This means that A can obtain control of B. Then, if from account B, it is possible to send input to another vulnerable program running under account C on same or different host, then principal A can take control of principal C after exploiting two program bugs. This illustration is exemplary. If these programs and accounts are spread over different hosts and operating systems, then the MMVA considers this in the analysis.

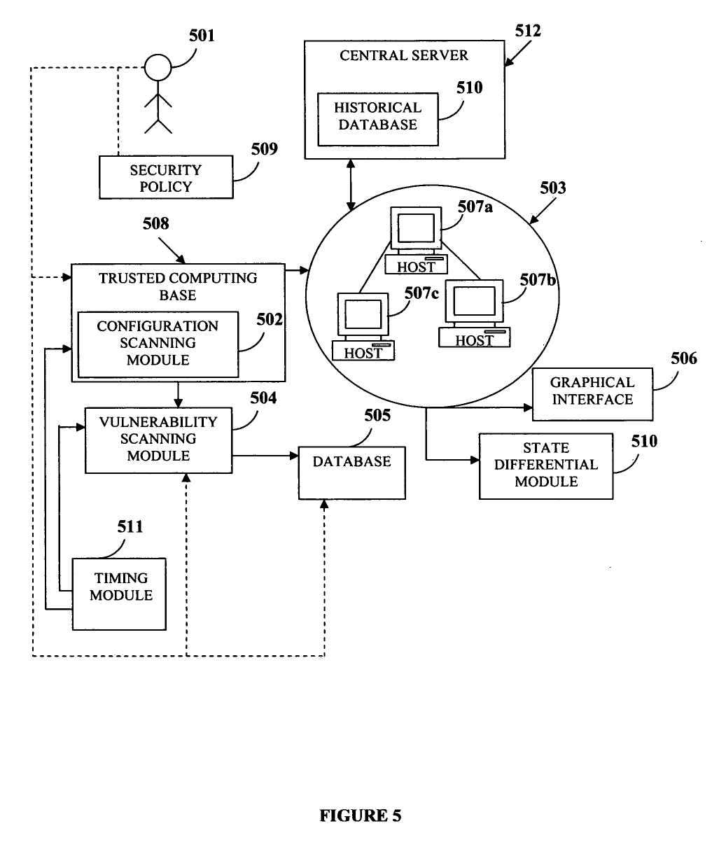

FIG. 5 illustrates a system for determining potential privilege escalation attacks in a network 503 comprising a central server 505 and a multiplicity of hosts 507 in the domain of an administrator 501. A configuration scanning module 502 performs a configuration scan on the network 503 at predetermined time intervals. The configuration module 502 analyzes the network 503 to acquire information of the different components in the network 503 such as the deterministic behavior of a component, the limited number of mechanisms by which each component interacts with other components, etc. The configuration scanning module 502 runs on a trusted computing base 508 with administrative privileges. A vulnerability scanning module 504 conducts a vulnerability scan using the result of the configuration scan at predetermined time intervals. The vulnerability scanning module 504 may be used to determine network 503 configuration vulnerabilities as well as single host 507 configuration vulnerabilities. The MMVA determines how the adversary can escalate their privileges on a single host, using misconfigurations in one or more of files, services and registry keys. The vulnerability scanning module 504 queries the configuration of services and other operating system objects and also finds unprecedented and unknown vulnerabilities. The vulnerability scanner 504 scans the entire registry and identifies the registry keys whose data contain the name or path of an executable file or library, and further investigates the security descriptor for the identified registry keys to determine if the content in the register key can be overwritten by an adversary. The vulnerability scanning process comprises the application of vulnerability rules, further comprising the steps of determining the identity of the vulnerability, the path of the vulnerable program, the identity of the host 507 comprising the vulnerable program, whether the vulnerability can be exploited locally or remotely, consequences of the vulnerability being exploited, capturing transitive dependencies, etc. Vulnerability scanning further comprises the step of scanning the entire registry and identifying registry keys whose data contain the name or path of an executable file or library, and further investigating the security descriptor for the identified registry keys to determine if the registry key's content can be overwritten by an adversary.

The configuration scanning module 502 and the vulnerability scanning module 504 run on separate computing platforms. The separation of configuration scanning module 502 and vulnerability scanning module 504 reduces the size of the trusted computing base 508 and the size of the configuration snapshot. The timing module 511 schedules configuration scan of configuration scanning module 502 and vulnerability scan of vulnerability scanning module 504. A database 505 stores the configuration scan results of the configuration scanning module 502 and the vulnerability scan results of the vulnerability scanning module 504. The state differential module 510 compares the states of two subsequent configuration scans of the configuration scanning module 502. The administrator 501 provides administrative privileges for the configuration scanning module 502 and provides a security policy 509. The security policy 509 comprises binding information specifying principal binding that maps a principal symbol to its user accounts on network 503, and hosts 507 and data binding that maps a data symbol to a path on the machine.

The administrator 501 may be a security expert, a bug expert and a system administrator 501 or a combination thereof. The system administrator 501 specifies the local element of the network 503, the users and the data. The security expert specifies component behavior. The security expert specifies the detailed security semantics of the operating system. The bug expert specifies known bugs in a machine readable format.

The graphical user interface 506 renders the results stored in the database 505 in a pictographic representation of privilege escalation. The pictographic representation makes it convenient for the system administrator to visualize the attacks. The complexity of the pictographic representation of the privilege escalation is determined by the number of atomic escalation possible. Thus, the total number of escalations possible in a pictographic representation is a quadratic function, and therefore it is feasible to visually identify potential privilege escalations using the pictographic representation.

The graphical user interface also stores the results in an appropriate electronic medium so that the results of MMVA be used by other programs. From the pictographic representation, MMVA can generate an attack tree version of the results.

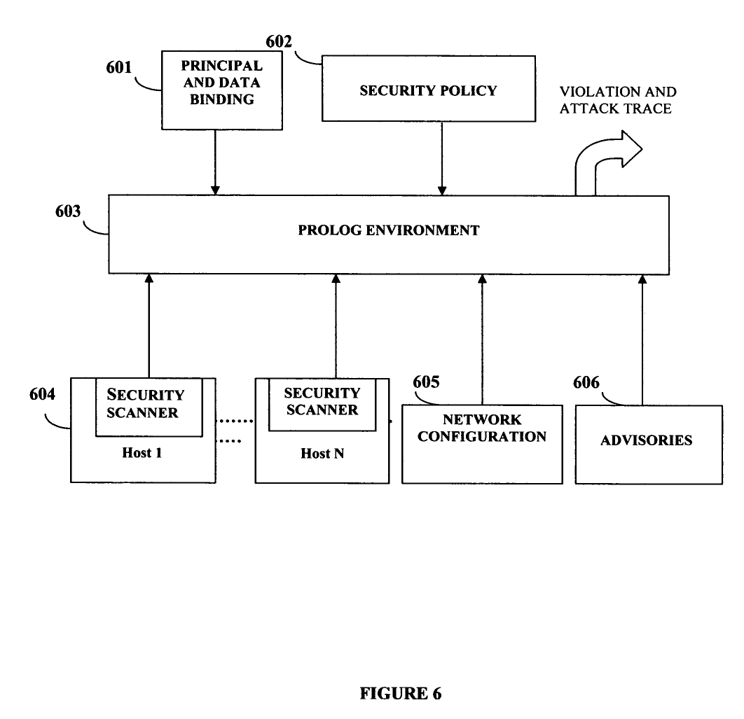

FIG. 6 illustrates the working of a multi-host multi-stage vulnerability analyzer (MMVA). A configuration scanner 604 runs asynchronously on each host 507. The security scanner 604 can be directed to extract configuration parameters on a host 507. For example, it can output the information of a service program 604 such as port number, privilege, etc. The output is then converted into Datalog, a polynomial-time subset of Prolog clauses. The use of Prolog herein is exemplary and may be substituted by a person skilled in the art with an appropriate programming language or other tools to suit the requirements.

The MMVA models network 503, such as router and firewall 602, configurations as abstract host 507 access-control lists (HACL). Network 503 configuration information can be provided by a firewall 802 management tool such as the smart firewall 605. The vulnerability scanner 604 formalizes the procedure of identifying the presence of vulnerabilities on computer systems. The security scanner 604 takes such formalized vulnerability definitions and tests a machine for vulnerable software. The result of the test is then converted into Datalog clauses 606. Principal binding maps a principal symbol to its user accounts on network hosts 507. In a multistage attack, the semantics of the vulnerability and the operating system determine an adversary's options in each stage. This is encoded as horn clauses (i.e., Prolog), where the first line is the conclusion and the remaining lines are the enabling conditions 602. In MMVA, a policy describes the data accessible to each principal. Any data access not explicitly allowed is prohibited 603.

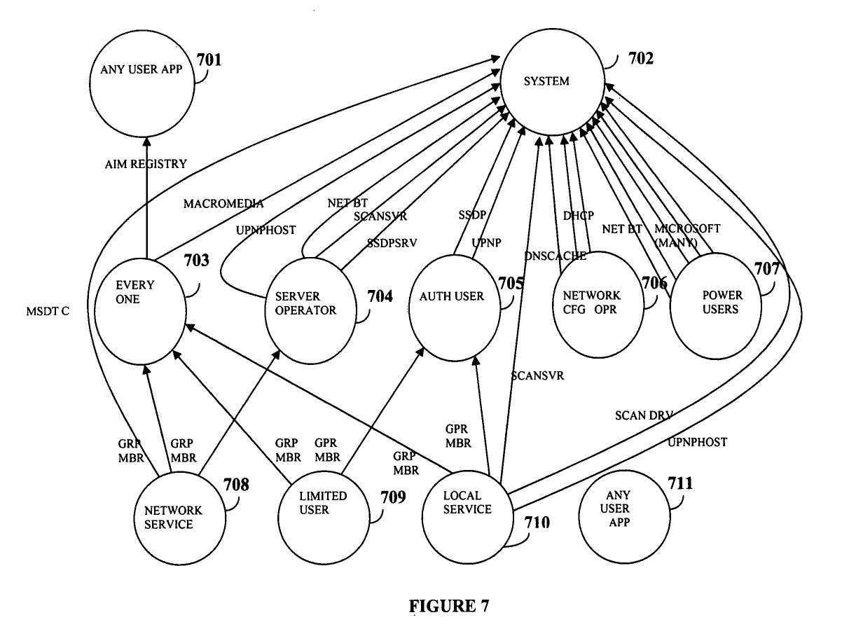

FIG. 7 illustrates the privilege escalations found in a default configuration of an exemplary operating system. Limited user 709 is an unprivileged user. Network service 708 and local service 710 are low-privileged accounts used to run operating system programs. Everyone 703, server operator 704, authorized user 705, network configuration operator 706, and power users 707 are groups. The arcs labeled grp mbr show that the user is a member of the group. All other arcs show privilege escalations. In a system 702, installing password sniffers to launch further attacks in the guise of any ordinary user are possible.

In the default configuration of the exemplary operating system, the simple service discovery protocol (SSDP) and the universal plug and play device host service (uPnP) in FIG. 7 grant permission to configure the service to the authenticated users group 705. Limited user 709 who is a normal unprivileged user is a part of the authenticated users 705 group and hence a normal user 709 can configure the executable and the account under which these services run. Then, the adversary needs to make the service reload the new configuration. The adversary needs to wait for the service to be restarted. For example, the adversary could force the system administrator 501 to reboot the machine by consuming too many resources so that the system is too slow to respond. The exemplary pictographic representation of FIG. 7 shows that the software running on even professionally managed hosts 507 has serious problems in using the operating system's access control model resulting in serious privilege-escalation vulnerabilities.

When a principal is granted the service change configuration permission, the principal is also granted service stop and service start permissions. The same service change configuration mechanism, the access-control decisions give paths from local service 710, network service 708, configuration operators 706 and server operators 704 to the local system 702. The local Service 710 account has permission to configure the uPnP, smart card services (SCardSvr) and the smart card helper service (SCardDrv). The network service 708 account has permission to configure the Microsoft distributed transaction coordinator service (MSDTC). The server operators group 704 has permission to configure uPnP, SSDP, NetBios over TCP/IP (NetBT), and SCardSvr. The network configuration operators group 706 has permission to configure the dynamic host 507 configuration protocol (DHCP), NetBT and Dnscache services. This defeats the principle of least privilege that was the motivation for creating local service 710 and server operators 704. If the adversary were to find a buffer overflow bug in a program running as local service 710, this escalation path enables the adversary to take control of the host.

There are many privilege-escalation paths from power users 707 to local system 702. The MMVA helps in finding many such escalation paths. The everyone group 703 was granted the permission to configure the macromedia licensing service. The standard configuration of any user application includes a registry entry binding the name of a dynamic link library (DLL) file to be loaded and executed by any user application software. The access permissions permit any user to write this entry. The attacker can substitute the name of their own DLL and wait for some other user application user 701 to execute it.

It is possible that weak configuration on a file or registry key's security descriptor can allow an adversary to modify the resource state. Next, the adversary can inject corrupted data into a higher privileged process reading the corrupted data. Sometimes, the data corruption presents the adversary with an immediate opportunity to attack. If the adversary is able to overwrite a driver file, then the adversary can corrupt the kernel and hence get control of the host 507. If an adversary can write to a program used in the operating system startup, then the adversary can compromise the integrity of the host and all the users. Alternatively, the adversary will try to write to a DLL that is loaded by a more privileged process. If the adversary can write to a registry key storing the executable or library name to be executed under certain conditions, it provides the adversary with another avenue of attack. Sometimes, a registry key stores the name of a library that is loaded by processes. If a process loads or executes the file references by a registry key, and if the adversary can write to the registry key, then the adversary can compromise the process. If the adversary can inject data into a process executing at a higher privilege level, the adversary can immediately gain access to the higher privilege level. For any object, a WRITE DAC permission can be used to change the security descriptor of the object and then take control of the object. A FILE WRITE permission can be used to overwrite a file and then take control of the principal executing the file or loading the library. A KEY WRITE can be used to overwrite the contents of the registry key and take control of whoever trusts this registry key. A SERVICE CHANGE CONFIG can be used to overwrite the attributes of the service. In particular, the adversary could configure a malicious program to be executed when the service is started. The adversary could also configure the user account which runs the program to be an administrator. If the adversary could cause the service to be restarted for example rebooting the machine, the malicious program runs as an administrator. After compromising the administrative account, the adversary can get complete control of the host 507 and any principal trusting the host.

The solution to the large network 503 management problems is a rule-based expert system MMVA that integrates configuration scanning, vulnerability scanning and automatically determines the transitive closure of all security attacks on the network 503. After determining all possible accesses, the MMVA identifies accesses that are not allowed by the administrator. The accesses that are not allowed are security attack paths.

MMVA reasoning rules specify semantics of different kinds of exploits, compromise propagation, and multi-hop network 503 access. The MMVA rules are designed so that information about specific vulnerabilities is factored out from the data generated by vulnerability scanners. The interaction rules characterize general attack methodologies such as Trojan Horse client program, not specific vulnerabilities. Thus, the rules do not need to be changed frequently, even if new vulnerabilities are reported frequently. The predicates in the system that model each of the following properties:
Vulnerabilities
Exploit propagation
User and data binding
User behavior
Network 503 behavior
Host configuration
Security policy 509
   vulScannerOutput(Host, VulId, ProgramPath) is a predicate specifying that vulnerability with identity VulId has been found in the program located at the path ProgramPath on host Host.
   vulProperty(VulId, ExploitRange, ExploitConsequence) is a predicate specifying whether the vulnerability VulId can be exploited locally or remotely and what happens when the vulnerability is exploited. ExploitRange is one of local or remote. Exploit consequence is one of privilegeEscalation, denialOfService, confidentiality Compromised and integrity compromised.
   dependsOn(Host, ProgramPath, LibraryPath) is a predicate that specifies on the host ‘Host’, the program at the path ProgramPath uses the library at path LibraryPath. vulExists(Host, Program, ExploitRange, ExploitConsequence) is a derived predicate that specifies that a vulnerability exists in a host 507 along with information about whether it is remotely exploitable and its consequences. The predicate is as follows:
vulExists(Host, Program, ExploitRange, ExploitConsequence):
vulProperty(VulId, ExploitRange, ExploitConsequence),
vulScannerOutput(Host, VulId, Program).

If there is a security bug in a library used by a program, then the program could be vulnerable. This is expressed as:
vulScannerOutput(Host, VulId, ProgramPath):
vulScannerOutput(Host, VulId, LibraryPath),
dependsOn(Host, ProgramPath, LibraryPath).
   Capture transitive dependencies if library Library1 uses Library2 and library Library2 uses Library3, then Library1 uses Library3. Formally this is written as follows:
dependsOn(Host, Library1, Library3):
dependsOn(Host, Library1, Library2),
dependsOn(Host, Library2, Library3).

The mechanism of exploiting each vulnerability is distinctive. For example, the specific details of exploiting a buffer overflow bug in simple mail transfer protocol (SMTP) server would be different from a buffer overflow bug in hypertext transfer protocol (HTTP) server. However, there are lots of common traits between these bugs. For example, both these programs are network 503 servers, where programs listen over the network 503 for incoming requests. Thus, an adversary can attempt to exploit these bugs over the network 503. Typically a buffer overflow bug results in crashing the server program (an example of denial-of service attack), or capturing the server program's privilege (privilege-escalation attack). When answering the question: what happens after a successful attack, the details of the specific attack become unimportant, and it is sufficient to know whether the server program crashed or has been completely taken over to determine the overall effects of a successful attack. The mechanisms of attacking different client programs are surprisingly similar. The mechanism an adversary would use to attack vulnerabilities in these programs is similar, such as sending a malicious file that triggers a buffer overrun bug within the application to take over the process running on behalf of the target. A similar technique is employed in exploiting vulnerability in a Web browser, an e-mail client, or an instant messenger client. To facilitate these exploits, the adversary will deliver a malicious web page to a vulnerable web browser or its components, or a malicious e-mail to an e-mail client or send a malicious instant message to the user using a vulnerable client. When vulnerability is reported on vulnerability reporting mailing lists, typically the advisory contains information like whether the vulnerability is remotely exploitable or locally exploitable and whether the vulnerability results in a denial of service or privilege escalation. Such information is also readily available in machine-readable databases 505 on the Internet 801. Such meta-information is valuable in conducting a transitive closure of all bugs on a network 503 to understand how an adversary can launch a multi-stage multi-host attack on the network 503. How different kinds of exploits are modeled is described here. Predicates that are used in the exploit rules are:

execCode(P, H, UserPriv) is a predicate specifying that principal P can execute arbitrary code with privilege UserPriv on host H.
netAccess(P, Src, Dest, Protocol, Port) is a derived predicate specifying that principal P can send packets from machine Src to port Port on machine Dest through protocol Protocol. networkService(Host, Program, Protocol, Port, Priv) is a predicate specifying that a service program Program is running on host Host at privilege level Priv. This program is serving requests over the network 503 by listening on port Port of protocol Protocol.
setuidProgram(H, Program) is a predicate specifying that Program is a setuid program on host H.

In remote privilege escalation, if an adversary is trying to attack a network server program, the adversary will be able to successfully attack the program only if the following conditions are met:
A vulnerable program is listening on the network 503.
The vulnerability can be remotely exploited.
   The network 503 configuration allows the adversary to send a malicious packet(s) to the port the program is listening on.
   The network server programs that accept input from the network are considered exploitable over the heterogeneous network if the vulnerability scanner reports that the server programs have known bugs.

If the bug is a privilege escalation bug, upon on successful attack, the adversary gets hold of the network server's process, thus getting hold of the user id running the network server process. It is written formally as:
% % Remote network server attack
execCode(Attacker, Host, ProgramUserId):
vulExists(Host, Program, remoteExploit, privilegeEscalation),
networkService(Host, Program, Protocol, Port, ProgramUserId),
netAccess(Attacker, AttackerSource, Host, Protocol, Port).

In the formalism of Datalog, a polynomial-time subset of Prolog, an identifier starting with such as AttackerSource is an anonymous variable, and it can bind to any value. So, in the above rule the predicate netAccess(Attacker, AttackerSource, Host, Protocol, Port) means that it does not matter from which host the Attacker launches the attack

In a local privilege escalation, to attack the privileged programs, the adversary first obtains access to some privilege level on the target host 507, and then exploits the vulnerability in the privileged program. An adversary can attack a privileged program if it is vulnerable. The vulnerability can be locally exploited. The adversary already has access to the host 507. Upon successful attack, the adversary gets hold of the privileges of the privileged program. It is encoded formally as:
% % Local attack against a privileged program
execCode(Attacker, Host, ProgramUserId):
vulExists(Host, Program, localExploit, privilegeEscalation),
privilegedProgram(Host, Program, ProgramUserId),
execCode(Attacker, Host,_SomeUser).

On many occasions, programming flaws in the kernel of the operating system resulted in both locally exploitable and remotely exploitable vulnerabilities. Hence, operating system kernel is modeled as both a network 503 service running as root, and a local privileged program. The consequence of exploiting a privilege escalation bug in kernel (either local or remote) will result in a compromise of the administrative account of the machine and hence the whole system.

In remote-exploit-client, an adversary can attack a client program if the following conditions are met:

The program is vulnerable to a remote exploit. The program is client software with privilege Priv. The attacker is some principal that originates from a part of the network 503 where malicious users may exist. The consequence of the exploit is that the attacker can execute arbitrary code with privilege Priv. It's encoded formally as:
execCode(Attacker, Host, Priv):
vulExists(Host, VulID, Program),
vulProperty(VulID, remoteExploit, privEscalation),
clientProgram(Host, Program, Priv),
malicious(Attacker).

After exploiting a client or server program, the adversary gets hold of a certain privilege level on a host 507. Among other things, one of the things the adversary could try is to tamper with critical operating system files like the password file, kernel program, and programs in the system directory. Or the adversary could try to steal confidential data from users' directories. Thus there is a need to model a file access semantics.

In an operating system, the permissions that can be placed on an object are read, write and execute. When a principal is granted permission to a file object, the operating interprets the permissions as follows: ‘read’ Permission to read the file. For directories, this means permission to list the contents of the directory. write permission to write to (change) the file. For directories, this means permission to create and remove files in the directory. execute permission to execute the file (run it as a program). For directories, this means permission to access files in the directory. There are three categories of users who may have different permissions to perform any of the above operations on a file object: the file's owner, the file's group and everyone else. localFileProtection(Host, User, Access, FilePath) is a predicate specifying that the User on machine Host 507 can have specified Access to the file FilePath. accessFile(Principal, Host, Access, Path) is a predicate specifying that Principal can access the file specified by Path on Host 507. Access can be one of read, write and execute. If an attacker Attacker can execute code on the machine Host 507 as a user User, then attacker can access whatever files User can access. This is encoded formally as:
accessFile(Principal, Host, Access, Path):
execCode(Principal, Host, User),
localFileProtection(Host, User, Access, Path).

localFileProtection(Host, User, Access, Path) is a operating system specific predicate. This predicate understands the access control semantics of the operating system.

For Windows XP/NT,2000/Vista, this translates into the algorithm titled: localFileProtection(Host, User, Access, Path):

userToken(Host, User, Token),

windowsAccessCheck(allowed, ObjProtection, Access, Token)

objectProtection(Host, Path, ObjProtection)

The predicate windowsAccessCheck(Result, ObjProtecton, Access, Token) is described later herein.

For a Windows 98 and 95 system, this predicate is expressed as:
localFileProtection(Host, User, Access, Path):—true
meaning any user can have any access to any file.

The predicate objectProtection(Host, Path, ObjProtection) is emitted by the configuration scanner and is an operating system specific predicate. ObjProtection describes the protection on an object. For Windows XP, Vista, 2000 and NT systems, an example predicate is shown in the section titled “Modelling Windows Access Conrol Algorithm”.

For a file Unix, Solaris, AIX, Linux (Red Hat, Debian, Fedora, Mandrake and other) host that follows the standard UNIX user-group-world read-write-execute semantics, the objectProtection predicate records the state of each access control bit. For example, standard rwx-rwx-rwx on /bin/bash on host H following this semantics translates into obectProtection(H, /bin/bash, securityDescriptor(user=root, group=root, [user=[read, write, execute], group=[read, write, execute], world=[read, write, execute)).

Another sample predicate is:
obectProtection(H, /bin/kernel.exe, securityDescritpor(user=root, group=root, [user=[read, write, execute], group=[read,execute], world=[read, execute)).

For a host whose operatig system (UNIX, Red Hat Linux, Fedora Linux, Debian Linux, AIX, HP-UX etc.) follows standard Unix semantics:
localFileProtection(Host, User, Access, Path):

userToken(Host, User, Token),

unixStandardAccessCheck(allowed, ObjProtection, Access, Token)

objectProtection(Host, Path, ObjProtection).

The predicate unixStandardAccessCheck(Result, ObjProtection, Access, Token) is implemented as follows:
unixStandardAccessCheck(Result, ObjProtection, Access, Token):

if the owner of the token matches the object's owner, then grant the

permissions asked

else

if the group of the token matches the object's group,

if the permission asked is allowed, then request is granted
else
if the group permission is write, the request is granted
else the request is denied
else
if the world is granted the requested access, the request
is granted
else the request is denied.

Token contains information about the ‘userID’ and group of the process and the user.

In case the operating system or file system does not support the standard rwx-rwx-rwx user-group-world access control semantics, and the operating system uses access control lists instead, then an algorithm very similar to the WindowsAccessCheck is used. In WindowsAccessCheck, has two components: 1) the algorithm to traverse the access control list, and 2) algorithm to match if the specified permission is granted in a single access control entry. The algorithm to see if the specified permission is granted in a single access control entry looks up the permissions allowed or disallowed by this access control entry and allows or disallows the access if it is not present in the current access control entry.

This makes the system immediately applicable in UNIX like environments where the filesystem does not support rwx-rwx-rwx user-group-world semantics. For example, one could be running a Red Hat Linux box with Andrew File System. It is straightforward to develop the Access Control System for Andrew File System by reading the description of WindowsAccessCheck.

The low-level operating system deal with 32-bit integers as user identifiers in UNIX based systems and Security Identifiers (SID) in Windows based systems. Users typically log on to a host by using a high level name such as ‘joe’. The user is represented in predicates such as execCode(alice, Host, bob) are high-level. However in the operating system object protection structures, the users are represented as low-level entries. To solve this problem, the high level identifier are mapped to low level identifier in an operating system specific manner.

For a Windows host:
Everyone to S-1-1-0
Administrators to S-1-5-32-544
   These values are applied by applying the appropriate operating system function to perform the translation. Similarly, in UNIX based systems, root is translated to 0 alice is translated to 500 etc. by looking up appropriate configuration (/etc/passwd and /etc/shadow and /etc/group, etc.).

A networked file system allows sharing a file system between many computers, so that one could easily access files from all of them. In cluster environments where there a large number of identical machines, the system administrator cannot maintain each machine. The system administrator needs to maintain a single host 507 and allow the changes to propagate to other hosts 507 automatically using networked file systems.

After obtaining certain access on a host, one way an adversary can propagate the attack to other hosts is to use the networked file systems. The adversary corrupts the file on the client share, and the file system copies the changes back on to the server share. From the server share, the corrupted file can automatically propagate to other clients mounting the share. There a large number of networked file systems, like Andrew file system (AFS), network file system (NFS) and server message block (SMB, Samba). An exemplary modeling of the network file system (NFS) is illustrated below.

After obtaining access to a host, another way for the adversary to propagate the attack is to identify if he can corrupt some of the system files and any important files that are used by the host's administrative account or other users' accounts. For example, he may wish to overwrite the operating system kernel (C:\WINDOWS\system32\ntoskrnl.exe in Windows XP host, /boot/vmlinuz-2.6.9-42.0.3.EL on CentOS 4.4, etc.). Another strategy would be to overwrite others users's home directories if the permissions are weakly configured on these directories. (/home/user in CentOS 4.4, C:\Documents and Settings in Windows XP, etc.). Another strategy is to try and corrupt the files or other objects used in the operating system boot process, thus hijacking the boot processes (files in /etc/rc.d/init.d/ directory for Fedora Core 6 Linux, files referenced in the Service Control Manager for auto-start services programs in Windows XP, etc.). Another strategy is to corrupt files that are likely to be used by the administrative account of the host. In the system and method described herein, these privilege escalations are modeled inside a single host as described below.

In this context, a list of critical targets for the attacker is optionally created by the configuration scanner. These are identified as follows:
Make a scan of the complete file system by using operating system specific code.
Ignore the file if it is not executable code or script
However, user home directories of users are included in the list.
Make a list of all files and classify them into one or more of the following groups:
   Each file in the above list is either a user home directory or an executable file. For each of these files, we identify who is a potential user of the file as follows:
If the file is a home directory, the potential user is the owner of the directory.
If the file is in one of the system directories (/boot/ /bin, /sbin, /usr in Fedora Core 6, Debian Linux etc., C:\Program Files and C:\Windows and C;\Windows\system32 in Windows systems), then the potential users of the program is all user of the host.
For all other files, the potential user of the file is owner of the file.
   After identifying the potential user(s) of the each of the files, local privilege escalation are identified as follows:
execCode(Attacker, Host, Target):

localFileProtection(Host, Attacker, write, Path),

PotentialUser(Target, Path).

This rule captures all the potential local privilege escalation attacks using the file mechanism. Later in this specification, dynamic tracing to identify which user is using what files to understand the privilege escalations possible is shown. This local privilege escalation by files is possible by other means such as services and registry keys, WMI keys, processes, network sockets, interprocess communicaton channels such as shared memory, named pipes, message queues, semaphores, waitable timers, mailslots, network ports, operating system and program services. The analysis for the attacks using these additional mechanisms is similar.

NFS protocol is based on remote procedure call (RPC). NFS is assigned an RPC protocol number of 100003. nfsExportInfo(Server, Path, Access, Client) nfsMounted(Server, ServerPath, Access, Client, ClientPath) are predicates that are generated by looking at the NFS configuration file on the client side. However, if an administrative account is compromised on the client side, then the attacker can mount any files. This is encoded as:
nfsMounted (Anything):
execCode (P, Client, root).

If files are mounted on the client side using the NFS protocol, and if the adversary can access files on the client side, then the adversary can also access the files on the server side.
This is encoded as:
accessFile(P, Server, Access, SrvPath):
nfsExportInfo(Server, Path, Access, Client),
nfsMounted(Server, SrvPath, Access, Client, ClntPath),
netAccess(P, Client, Server, rpc, 100003).
accessFile(P, Client, Access, ClntPath).

An attacker can propagate a multi-stage multi-host attack by sending malicious packets over the network 503 to compromise vulnerable server programs. Packet flow is controlled by switches, routers and firewalls 802. Modeling the elements of the network 503 infrastructure is important in determining the options an adversary has in attacking a network. Network analysis tools is operated which produce host 507 to host reachability information. This information is abstracted as a set of hacl. The hacl is fed into vulnerability analysis. A host 507 access control list specifies all accesses between hosts 507 that are allowed by the network. It consists of a collection of entries of the following form:

hacl (Source, Destination, Protocol, DestPort). These abstracted entries can be used, as follows, to determine the network 503 access an adversary has as follows:
netAccess(P, H2, Protocol, Port):
execCode(P, H1, Priv),
hacl(H1, H2, Protocol, Port).

If a principal P has access to machine H1 under some privilege and the network 503 allows H1 to access H2 through protocol and port, then the principal can access host 507 H2 through the protocol and port. This allows for reasoning about multi-host attacks, where an attacker first gains access on one machine inside a network 503 and launches an attack from that machine.

The analysis described earlier can be used to compute the resources and privileges a user can either access or obtain. An administrator can access all the resources of the administrator domain and can obtain the privileges associated with any user in the administrator domain. This is normal behavior. On the other hand, a breach is created when an unauthorized user can access confidential files or can obtain unwanted privileges. There is a need for a mechanism to specify which accesses are allowed. In the framework provided by MMVA, the system administrator 501 specifies allowed behavior through a security policy 509.

The security policy 509 specifies the data each principal can access. Each principal and data is given a symbolic name, which is mapped to a concrete entity by the binding information. Each policy statement is of the form allow(Principal, Access, Data). The arguments can be either constants or variables (variables start with a capital letter and can match any constant). The following is an example policy:
allow(Everyone, read, webpages).
allow(user, Access, projectPlan).
allow(sysAdmin, Access, Data).

The policy states that anybody can read webPages, the user can have arbitrary access to projectPlan, and sysAdmin can have arbitrary access to arbitrary data. Anything not explicitly allowed is prohibited. The policy language presented in this section is quite simple and easy to make right. However, the MMVA reasoning system can handle more complex policies as well.

Principal binding maps a principal symbol to its user accounts on network 503 hosts 507. For example:
hasAccount(user, projectPC, userAccount).
hasAccount(sysAdmin, webServer, root).
Data binding assigns a data symbol to a data resource represented by an access path in the filesystem tree.
For example:
dataBind(projectPlan, workstation, ‘/home’).
dataBind(webPages, webServer, ‘/www’).
The binding information is provided manually.

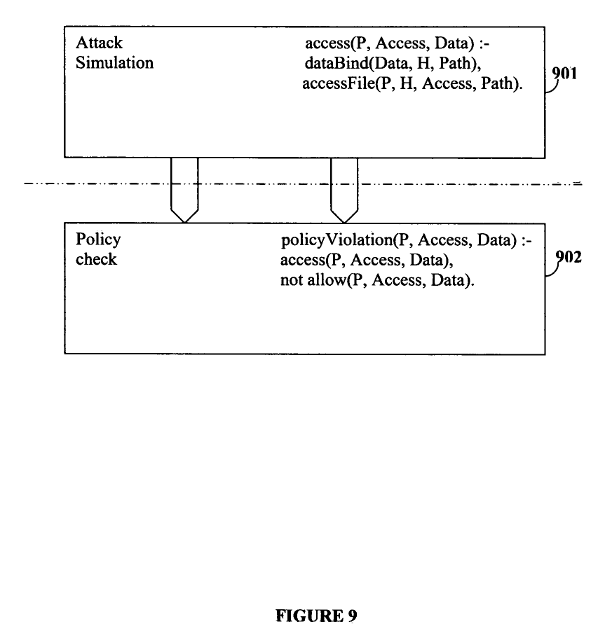

FIG. 9 illustrates an exemplarily vulnerability analysis algorithm which is divided into two phases: attack simulation 901 and policy checking 902. In the attack simulation phase 901, all possible data accesses that can result from multistage, multi-host attacks are derived. This is achieved by the following Datalog program.
access(P, Access, Data):
dataBind(Data, H, Path),
accessFile(P, H, Access, Path).

The attack simulation phase is useful to get an exhaustive list of which user can access what resource on the network. In the absence of a security policy this information is useful. Even in the absence of an adversary, or if it is not known where the adversary will attack from, or which user might become malicious, this list of who can access what is useful. However, at times this raw trace can become too large. If policy is supplied, then the accesses can be validated using the policy. A sample example is shown below. Any access that is not allowed by the policy is a privilege escalation. Even if a policy is not specified, our analysis system helps the cyber security manager(s) come up with a security policy by asking the user a couple of questions, as described earlier in the document.

If data is stored on machine H under path Path, and principal P can access files under the path, then P can access data. The attack simulation 901 happens in the derivation of accessFile, which involves the interaction rules and data tuple inputs from various components of MMVA. In the policy checking phase 902, the data access tuples output from the attack simulation phase 901 are compared with the given security policy 509. If an access is not allowed by the policy, a violation is detected. The following program performs policy checking 902.
policyViolation(P, Access, Data):
access(P, Access, Data),
not allow(P, Access, Data).

If a security policy is not defined by the system administrator, then a security policy can be generated in the following manner:
Run the analysis described herein to perform an analysis to identify which principal can access what resource on a host or a network. This step will produce a large number of predicates such as “user Bob can access (write mode) file c:\windows\system32\kernel.exe” or “user Bob can access (read mode) file /bin/bash”
Classify files and other objects by one or more of the following criteria:
   The files are in a directory or a sub directory
   The files have a pattern such as ending with a .dll, .lib, .exe, .cab, etc.
Classify users into various classifications by using one or more criteria such as:
   Part of a particular group like “Power users” or “Limited Users” (Windows) or “httpd” (in Linux) etc.
   Users of a machine
We ask the cyber security manager questions such as: “This set of files can be accessed by this user, is it okay?”
   In the system disclosed herein, we ask questions like “do you trust the users of group “Everyone”?” (Windows) and “do you trust “user Bob to access all files in the filesystem? ” “Can the Administrator access C:\Windows.exe for write?”. We store the administrators' response and remove the predicates from the set of computed accesses.
   The above process for collecting information from the cyber security manager is repeated, with information collected in each iteration as to whether or not a particular set of accesses is allowed. This information collected by system disclosed herein is the security policy for the host and network.
In some cases, if there are too many important files that can be accessed by users, then it is more convenient to ask the cyber security manager if he trusts this user or set of users to get complete access to the machine. In a sample session, the set of questions and responses from our system looks as follows:
   “do you trust “Everyone group”?”
   Do you trust Sid S-1-5-19(NT AUTHORITY\LOCAL SERVICE) [y/n]?n
   Do you trust Sid S-1-5-32-545(BUILTIN\Users) [y/n]?n
   Do you trust Sid S-1-5-32-546(BUILTIN\Guests) [y/n]?n
   Do you trust Sid S-1-5-32-549(BUILTIN\Server-Operators) [y/n]?n

The MMVA tool can be used to compute how the adversary can put multiple attack steps together to get a multi-step multi-stage attack. Thus, we are able to compute the net affect of doing all possible privilege escalations such as transitive closure of privilege escalations. This is done by asking the appropriate system to compute all possible matches for the predicate execCode(Source, Host, Target).

As an example, for the exemplary illustration of privilege escalations found in a default configuration of an operating system, computing all possible matches for this predicate include:
execCode(NetworkService, Example, Everyone)
execCode(Everyone, Example, System)
execCode(NetworkService, Example, System)

Thus the system disclosed herein computes the transitive closure of privilege escalations, for example, how one or more privilege escalations can be used together to obtain a level of access not possible with just one of the accesses. By incorporating meta information about each attack step such as the specific program responsible, MMVA can also compute how different attack paths may be executed in parallel. Thus, in the exemplary system in FIG. 7, we are able to identify that there are two ways of reaching System from Limited User, one through Everyone node and another through Authenticated User group. We are also able to find out that there are multiple paths from Server Operator to System through UPNPHOST, NETBT, SSDPSRV.

In the process of determining all possible privilege escalations, the tool disclosed herein optionally generates a pictographic representation by emitting a description of the privilege escalation graph, which will be rendered by appropriate programs such GraphViz toolkit from AT&T Research.
generatePictographicDescription:

execCode(Source, Host, Target),
write (Source−>Host\Target) to pictographic description

This pictographic description is then used by the appropriate graph drawing program to render the privilege escalations pictographically. This will emit the graphs for all privilege ecalations, potentially making the graph impossible to read. For example, in FIG. 7, because the administrative account is compromised from any node, it should be possible to get to any node from any node. To reduce the number of arcs that are shown in the graph, one skilled in the art can easily modify the single attack step modeling described to emit an atomic privilege escalation. This will ensure that our pictographic rendering system only renders each individual privilege escalation.

After computing all privilege escalations, the list of privilege escalatins can be stored in a database for future reference as follows:
computePrivEscAndStoretoDb:
execCode(Source, Host, Target)
store Source−>Host\Target in the database.

One simple system is to use a file for the database. In this case, the above store predicate looks like: write Source−>Host\Target to the database file. A simple “diff” between the results files at two points of time gives the user of MMVA system an idea how privilege escalations are evolving over time.

One usage of a MMVA is to conduct a “what if” analysis. For example, the administrator would like to know: will my network 503 still be secured if two CERT advisories arrive tomorrow since an important purpose of using firewalls 802 is to guard against potential threats. Even if there is no known vulnerability in the network 503 today, one may be discovered tomorrow. Analysis that can reveal weaknesses in the network 503 under hypothetical circumstances is useful in improving security. Performing this kind of hypothetical analysis is easy in a MMVA framework. A predicate bugHyp is introduced to represent hypothetical software vulnerabilities. For example, following is a hypothetical bug in the web service program httpd on host 507 webServer 806.
bugHyp(webServer, httpd, remoteExploit, privEscalation). The fake bugs are then introduced into the reasoning process.
vulExists(Host, VulID, Prog):
bugHyp(Host, Prog, Range, Consequence).
vulProperty(VulID, Range, Consequence):
bugHyp(Host, Prog, Range, Consequence).

The following Prolog program will determine whether a policy violation will happen with two arbitrary hypothetical bugs.
checktwo(P, Acc, Data, Prog1, Prog2):
program(Prog1),
program(Prog2),
Prog1 @<Prog2,
assert(bugHyp(H1, Prog1, Range1, Conseq1)),
assert(bugHyp(H2, Prog2, Range2, Conseq2)),
policyViolation(P, Acc, Data).

The two assert statements introduce dynamic clauses about hypothetical bugs in two programs. The policy check is conducted with the existence of the dynamic clauses. If no policy violation is found, the execution will back-track and another two hypothetical bugs (in two different programs) will be tried. @< is the term comparison operator in Prolog. It ensures a combination of two programs is tried only once. If there are two programs whose hypothetical bugs will break the security policy 509 of the network 503, the violation will be reported by ‘checktwo’. Otherwise the network 503 can withstand two hypothetical bugs.

There is a need to understand the current known vulnerabilities in software installed on the network 503 and determine whether any of the hosts 507 in the administrator's domain are vulnerable. To obtain information about the existence and exploit details of current known vulnerabilities, an administrator subscribes to vulnerability discussion and information dissemination mailing lists such as BugTraq, US-CERT's Cyber Security Bulletins, and Full Disclosure mailing list. This advisory details information such as the affected versions of the program, the affected versions of the operating system distribution that deliver the vulnerable software, how the adversary can exploit the vulnerability, and how the administrator can get the updated versions of the software that fix this vulnerability. The advisory mentions the details of the vulnerability in natural-language format and not in a format with formal semantics.

The MMVA scanner optionally scans the entire registry and identifies registry keys whose data contain the name or path of an executable file or library. A registry key is used to store the file or library to invoke when certain conditions are met. If a sensitive key can be overwritten by the adversary, the adversary can make the key point to their executable content. The adversary then waits for the system to execute the adversary content. The MMVA identifies sensitive registry keys and for each sensitive registry key, this MMVA investigates the security descriptor to see if the key's contents can be overwritten by the adversary. The MMVA enumerates the services on a host 507 and investigates the security descriptor on each service if the service presents the adversary with an opportunity to attack the system. The MMVA scanner works in two phases. The first phase needs administrative privileges and collects all the configuration data into a database 405. The second phase does the analysis of the configuration data and the vulnerability definition and determines if the vulnerability specified by the definition exists on the host 507. In this design, only the first phase needs administrative privileges, the second phase can run under a non administrative account. Another advantage of separating the configuration collection from analysis is that configuration collection can be run before information about vulnerability is available. If configuration collection is run after vulnerability is publicly known, there is the possibility that the adversary has already compromised the machine. If the adversary has already compromised the host 507, then he may be able to hijack the security scanner 604, tricking the scanner to believe that the vulnerability does not exist. It is suggested that the configuration collector be run periodically, or run each time a change is made to the host 507 configuration, or when a vulnerability is reported and the results stored in a centralized server. When a vulnerability advisory is released, the vulnerability scanner can optionally check if the host 507 is vulnerable by running the analyzer on the centralized server, thus not relying on the information provided by the host 507 after vulnerability is publicly known. If one maintains configuration information on a centralized and trustworthy server, then it is easy to maintain a historical database 505 of the configuration of the host 507. When it is suspected that a host 507 has been compromised, a historical database 505 of host 507 configuration can be used to perform an analysis of what the adversary could have done after compromising a host 507. The MMVA determines all the places that an adversary can compromise because of a reported security vulnerability.

The MMVA is functioned on a small network 503 used by about seven hundred users. A subset of the network 503 was analyzed. This tool found a violation of policy because of vulnerability. The system administrators 601 subsequently patched the bug.

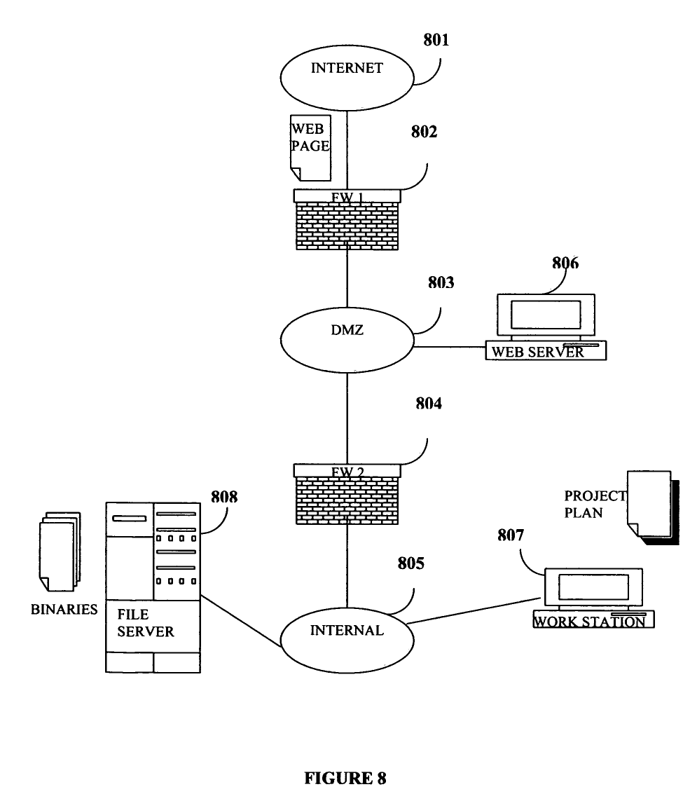

FIG. 8 exemplarily illustrates a network topology considered for network security analysis. There are three zones (internet 801, dmz and internal) separated by two firewalls 802 (fw1 and fw2). The administrators manage the web-server 806, the workstation 807 and the fileserver. The users have access to the public server workstation 807 which they use for their computing needs. The host 507 access control list for this network is:
hacl(internet, webServer, tcp, 80).
hacl(webServer, fileserver, rpc, 100003).
hacl(webServer, fileserver, rpc, 100005).
hacl(fileServer, AnyHost, AnyProtocol, AnyPort).
hacl(workStation, AnyHost, AnyProtocol, AnyPort).
hacl(H, H, AnyProtocol, AnyPort).
   The following Datalog tuples describe the configuration information of the three machines.
networkService(webServer, httpd, tcp, 80, apache).
nfsMount(webServer, ‘/www’, fileServer, ‘/export/www’).
networkService(fileServer, nfsd, rpc, 100003, root).
networkService(fileServer, mountd, rpc, 100005, root).
nfsExport(fileServer, ‘/export/share’, read, workstation).
nfsExport(fileServer, ‘/export/www’, read, webServer).
nfsMount(workStation, ‘/usr/local/share’, fileserver, ‘/export/share’).
   The fileserver serves files for the webServer 806 and the workstation 807 through the ‘network file system’ NFS protocol. There are actually many machines represented by workstation 807. The workstation 807 is managed by the administrators and run the same software configuration. To avoid the difficult of installing each application on each of the machines separately, the administrators maintain a collection of application binaries under ‘/export/share’ on fileserver so that any change like recompilation of an application program needs to be done only once. These binaries are exported through NFS to the workstation 807. The directory /export/www is exported to webServer 806.
Data binding.
databind(projectplan, workstation, ‘/home’).
dataBind(webPages, webServer, ‘/www’).

The principal ‘sysAdmin’ manages the machines with user name root. The principal user uses the workstation 807 with user name userAccount. For this organization, the primary worry is a remote attacker launching an attack from outside the network 503. The attackers are modeled by a single principal attacker who uses the machine internet 701 and has complete control of it. The Datalog tuples for principal bindings are:
hasAccount(user, workstation, userAccount).
hasAccount(sysAdmin, workstation, root).
hasAccount(sysAdmin, webServer, root).
hasAccount(sysAdmin, fileserver, root).
hasAccount(attacker, internet, root).
malicious(attacker).

The administrators need to ensure that the confidentiality and the integrity of user's files will not be compromised by an attacker. Thus, the policy is:
allow(Anyone, read, webPages).
allow(user, AnyAccess, projectPlan).
allow(sysAdmin, AnyAccess, Data).

The MMVA scanner was operated on each of the machines. The interesting part of the output was that workstation 807 had the following vulnerabilities:
vulExists(workStation, ‘CAN-2004-0427’, kernel).
vulExists(workStation, ‘CAN-2004-0554’, kernel).
vulExists(workStation, ‘CAN-2004-0495’, kernel).
vulExists(workStation, ‘CVE-2002-1363’, libpng).

The MMVA reasoning engine then analyzed this output in combination with the other inputs described above. The tool did find a policy violation, for example, bug cve-2002-1363 a remotely exploitable bug in the libpng library. The adversary creates a malicious image file that exploits the bug, then uploads this image to a popular website and waits for the user to download the picture from the site. When the user loads the image, the adversary obtains control of the user's account on workstation 807 machine by launching the exploit. A reasoning rule in the MMVA for remote exploit derives that the workstation 807 machine can be compromised. After obtaining control of the user's account on the host 507, it is trivial for the adversary to access projectPlan files because the user already has access to them. The reasoning rule for file access in our MMVA derives that the adversary can access projectPlan files. Thus, the projectplan data can be accessed by the attacker, violating the policy.

The MMVA determines the users and groups that have to be trusted to guarantee the host's integrity, by determining whether the paths from the users or groups to the system exist from the pictographic representation of the privilege escalation.

This MMVA framework works in the case of multistage attacks also. Consider a simulated attack on the network discussed in the above single stage attack example if the following two exemplary vulnerabilities are reported by the scanner:
vulExists(webServer, ‘CVE-2002-0392’, httpd).
vulExists(fileServer, ‘CAN-2003-0252’, mountd).

Both vulnerabilities are remotely exploitable and can result in privilege escalation. The corresponding datalog clauses from ICAT database 505 for example are:
vulProperty(‘CVE-2002-0392’,remoteExploit, privEscalation).
vulProperty(‘CAN-2003-0252’,remoteExploit, privEscalation).

The machine and network 503 configuration, principal and data binding, and the security policy 509 are the same as in the single stage attack.

The MMVA reasoning engine analyzed the input Datalog tuples. The Prolog session transcript is for example as follows:
   |?—policyViolation(Adversary, Access, Resource).
Adversary=attacker
Access=read
Resource=projectPlan;
Adversary=attacker
Access=write
Resource=webPages;
Adversary=attacker
Access=write
Resource=projectPlan;

A pictographic representation of privilege escalation illustrates the paths which an adversary can exploit vulnerabilities and break into a system. System administrators analyze these pictographic representations of privilege escalation to understand where their system's weaknesses lie and deploy appropriate security measures. FIG. 7 illustrates the pictographic representation of privilege escalations found in a default configuration of an operating system.

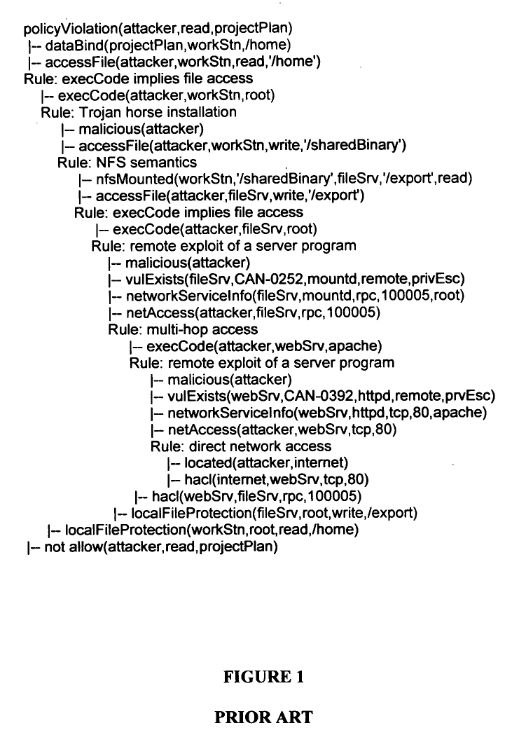

If a large number of escalations are possible, then a pictographic representation of attacks is efficient as compared with attack traces shown in FIG. 1. The number of attack traces will be exponential if there are a large number of escalations possible. On the other hand, the complexity of the graph is determined by the number of atomic escalations possible. MMVA computes the total escalations possible and runs in quadratic time. Thus, the total number of escalations possible is a quadratic function. Hence, representing the output as an attack graph has quadratic complexity.

An access control entry is encoded as the primitive predicate ace(aceType(Type), aceRights(RightsList), Sid) that specifies that an access control entry of type Type (one of ACCESS ALLOWED ACE TYPE or ACCESS DENIED ACE TYPE) grants or denies to the entities represented by the identifier ‘Sid’ the rights specified in the list RightsList. An example usage is:
ace(aceType(‘ACCESS_ALLOWED_ACE_TYPE’),
aceRights([‘FILE_WRITE_DATA’]),
sid(‘S-1-5-21-854245398-1637723038-725345543-1003’)).

The predicate dacl(AclList) encodes a discretionary access control list (DACL), where AclList is a list of access control entry predicates, storing the entries in the same order as they appear in the security descriptor. In case the oebject does not have any protection (.null DACL.), encode this as dacl(null). If the object has an DACL of length zero, then the DACL is encoded as dacl(□). All other DACLs are encoded as dacl([HeadAce | ACLTail]) where HeadAce is a predicate that describes the first access control entry and ACLTail is a list of predicates for subsequent access control entries. A sample DACL predicate is:
dacl([ace(aceType(‘ACCESS_ALLOWED_ACE_TYPE’),
aceRights([‘FILE_WRITE_DATA’]),
sid(‘S-1-5-21-854245398-1637723038-725345543-1003’))
   |
[ace(aceType(‘ACCESS_ALLOWED_ACE_TYPE’),
aceRights([‘FILE_READ_DATA’]),
sid(‘S-1-5-21-854245398-1637723038-725345543-1003’))
]
])
A security descriptor is encoded as the predicate
securityDescriptor(Owner, Dacl)
   where owner represents the security identifier of the owner and Dacl is a predicate that encodes the discretionary access control list. When a kernel makes an access control decision, the decision will require the ability decide what a single access control entry means. The predicate checkACE(Result, AceEntry, RequestedAccess, SidsList) is the predicate that models the decision making at a granularity of a single access control entry. Result is one of allowed, denied, AceEntry is an access control entry predicate, RequestedAccess the access requested and SidsList is a list of security identifiers of the groups the process token. The predicate checkACE(Result, AceEntry, Access, SidsList) means that an elementary access control decision, using the access control entry AceEntry, for a request Access by a principal whose list of security identity of the groups in the process token is SidsList, is Result (one of allowed, denied).
checkACE(allowed,ace(aceType(‘ACCESS_ALLOWED_ACE’), AceRights, Sid),
Access, SidsList):
accessInAceMask(Access, AceRights),
sidInGroup(Sid, SidsList).
checkACE(denied,ace(aceType(‘ACCESS_DENIED_ACE), AceRights, Sid),
Access, SidsList):
accessInAceMask(Access, AceRights),
sidInGroup(Sid, SidsList).
   The predicate sidInGroup(Sid, SidList) recursively searches the SidList to see if Sid is present:
sidInGroup(Sid, [Sid |_]).
sidInGroup(Sid, [_| Tail]):
sidInGroup(Sid, Tail).
   The predicate checkAccessList(Result, RequestedAccess, Acl, SidsList) models the algorithm the kernel uses to decide whether an access control list Acl allows or denies RequestedAccess to a principal with SidsList as the list of security identifiers of the groups in the process token. This predicate examines the Acl from first to last and unifies the ‘Result’ variable to allowed or denied accordingly. If there is no access control on the object, then the request is granted. If the end of the list is reached, then access is denied. Formally, we write this as:
checkAccessList(allowed, Access, dacl(null), SidsList).
checkAccessList(Result, Access,
dacl(acl([AclHeadEntry| AclTail])), SidsList):
(
checkACE(Result, AclHeadEntry, Access, SidsList);
checkAccessList(Result, Access,
dacl(acl(AclTail)), SidsList)
).
% An empty access control list denies access
checkAccessList(denied, Access,
dacl(acl(□)), SidsList).

In the formalism of Prolog, an identifier starting with (like RequestedAccess) is an anonymous variable, and it can bind to any value. So, in the above rule the predicate checkAccessList(allowed, RequestedAccess, dacl(null), SidsList) means that it does not matter what the requested access is and what SIDs are a part of the process token of the calling process.

When a principal accesses an object, the kernel looks up the process token of the process making the request to determine its credentials: the user, the privileges, the groups the user belongs to and the restricted groups the user belongs to. The predicate processToken(UserSid, Privileges, Groups, RestrictedGroups) encodes the credentials of the process requesting the access. UserSid is the user identity on behalf of whom the process runs, Privileges is the set of privileges (like SeTakeOwnershipPrivilege, SeSystemtimePrivilege) the process holds, Groups is the set of groups the user belongs to and RestrictedGroups is the set of restricted groups the user belongs to. A sample process token looks like:
processToken(‘S-1-5-21-1214440339-507921405-1060284298-500’,
checkAccessList(Result, Access,
dacl(acl(AclTail)), SidsList)).
% An empty access control list denies access
checkAccessList(denied, Access,
dacl(acl(□)), SidsList)
   In the formalism of Prolog, an identifier starting with (like RequestedAccess) is an anonymous variable, and it can bind to any value. So, in the above rule the predicate checkAccessList(allowed, RequestedAccess, dacl(null), SidsList) means that it does not matter what the requested access is and what SIDs are a part of the process token of the calling process.

The predicate windowsAccessCheck(Result, ObjectProtection, RequestedAccess, RequestingToken) models the algorithm the kernel uses in determining whether to permit an RequestedAccess access to an object with protection ObjectProtection by a process with token RequestingToken. The variable ‘Result’ is instantiated to allowed or denied accordingly. Formal description of the algorithm.

No ACL implies no protection. If a file does not have an Access Control List (.Null DACL.), then any access is permitted on the file. The formal rule is:
windowsAccessCheck(allowed,
securityDescriptor(Owner, dacl(null)),
RequestedAccess,
RequestingProcessToken).
   ‘SeTakeOwnershipPrivilege’ privilege gives write-owner access. The privilege SeTakeOwnershipPrivilege in the caller's token gives WRITE OWNER access to any resource. With WRITE OWNER permission, one can change the owner SID of a resource to one of the SIDs in the caller's process token. Technically, the SID in the process token will have to be marked as having the potential for being an owner. After obtaining the ownership of a resource, the adversary will be able to get full control of the resource by launching further attacks, as described below. Similarly, any super privilege will give the adversary complete control over all the resources of the host. These multi-step attacks are encoded as a single step as follows:
windowsAccessCheck(allowed, SecDescriptor, RequestedAccess,
processToken(Owner, PrivList, GroupSids,
TokenRestrictedSids)
):
hasSuperPrivilege(true, PrivList).
   % Check if token has a “super” privileges owner always gets access. The owner of a resource always gets WRITE DAC access. The owner can use the WRITE DAC permission to reset the ACL to give an arbitrary entity arbitrary access. Thus the owner of a resource always get full access to the resource. This is expressed as:
windowsAccessCheck(allowed,
securityDescriptor(Owner, Dacl),
RequestedAccess,
processToken(Owner, PrivList, GroupSids, TokenRestrictedSids).
   Consult the Access Control List. Evaluate the access control list from _first to last, trying to determine if an entry allows or denies the access. Formally, this is expressed as:
windowsAccessCheck(allowed,
securityDescriptor(ObjectOwner, dacl(Acl)),
RequestedAccess,
processToken(ProcessOwner, PrivList, Groups,
TokenRestrictedSids)
):
checkAccessList(allowed, RequestedAccess, Acl, Groups),
(processIsNotRestricted(TokenRestrictedSids);
/*; is the Prolog OR operand. */
processIsRestricted(TokenRestrictedSids),
checkAccessList(allowed, RequestedAccess,
Acl, TokenRestrictedSids)
).
   Everything else is denied. If none of the above rules match, then the access cannot be allowed and hence access is denied. This is modeled as:
windowsAccessCheck(denied, SecurityDescriptor, RequestedAccess, ProcessToken):
not windowsAccessCheck(allowed, SecurityDescriptor, RequestedAccess, ProcessToken).

In Atomic permissions, the RequestedAccessargument is an atomic permission like FILE READ DATA and FILE READ ATTRIBUTES. In practice, one requests more than one permission, like FILE READ DATA and FILE WRITE DATA.to read and write a file. To check for such nonatomic permissions, call on the corresponding access check function on each atomic permission requested. This is a deviation from the way the kernel implements the algorithm. However, this deviation is functionally equivalent when used with atomic predicates. The kernel implementation avoids calling the function more than once for nonatomic permission by doing some clever bit manipulation. Since it is not straightforward to do bit manipulation in Datalog, access check can only be called on an elementary permission like FILE READ DATA. This makes our reasoning rules easier to write and debug and thus increases the assurance of the system. However, Windows allows a principal to request more than one permissions. like all of FILE READ DATA, FILE WRITE DATA, DELETE, READ CONTROL, WRITE DAC.simultaneously. To model the behavior of Windows, when a principal requests both FILE WRITE DATA and WRITE DAC, the predicate invoked is:

windowsAccessCheck twice.the_first time with FILE WRITE DATA and the second time with WRITE DAC.

The predicate resource(Type, Name, Dacl) identifies various resources on a host. Type indicates the type of the resource The type may be one of service, registry and file. Name identifies the resource and Dacl is the protection on the resource. By scanning the host, one could generate the list of all the resources on a machine. The predicate userToken(Principal, Token) identifies that the principal ‘Principal’ gets the token ‘Token’ when the principal logs in. This predicate is generated for each user on the machine.

The canWrite(Principal, resource(Type, Name, Dacl)) is a derived predicate that specifies that principal ‘Principal’ can write the resource of type ‘Type’ (such as service, registry, file) identified by ‘Name’ and with a security descriptor Dacl. If the adversary has WRITE DAC or GENERIC WRITE permissions, adversary can write to the resource. Formally, this is expressed as:
canWrite(Principal, resource(Type, Name, Dacl)):
userToken(Principal, ProcessToken),
windowsAccessCheck(allowed, Dacl,
‘WRITE_DAC’, ProcessToken).
canWrite(Principal, resource(Type, Name, Dacl)):
userToken(Principal, ProcessToken),
windowsAccessCheck(allowed, Dacl, ‘GENERIC_WRITE’, ProcessToken)
   If the adversary has FILE WRITE DATA permission on a_file, the adversary could overwrite the file. Formally this is expressed as:
canWrite(Principal, resource(file, Name, Dacl)):
userToken(Principal, ProcessToken),
windowsAccessCheck(allowed, Dacl,
‘FILE_WRITE_DATA’, ProcessToken).
   If the adversary has KEY SET VALUE permission on a registry key, the adversary could overwrite the contents of the key. Formally this is expressed as:
canWrite(Principal, resource(registry, Name, Dacl)):
userToken(Principal, ProcessToken),
windowsAccessCheck(allowed, Dacl,
‘KEY_SET_VALUE’, ProcessToken).
   If the adversary has SERVICE CHANGE CONFIG permission on a service, adversary could reconfigure the service. Formally this is expressed as:
canWrite(Principal, resource(service, Name, Dacl)):
userToken(Principal, Token),
windowsAccessCheck(allowed, Dacl,
‘SERVICE_CHANGE_CONFIG’, Token);
   trusts(Principal, Resource) is a predicate that specifies that Principal trusts resource. If a principal executes code in a file, the principal trusts the file. Since any one who can configure a service can get administrative access to a machine indirectly, an administrator should trust any service resource. Formally this is expressed as: trusts(Administrator, resource(service, Name, Dacl)).
   If a principal Target trusts a resource(Type, Name, Dacl) and if a principal Attacker can write to this resource, then the adversary Attacker can launch a privilege escalation to Target. This is formally encoded as:
execCode(Attacker, Target):
canWrite(Attacker, Resource),
trusts(Target, Resource).

System administrators require the ability to measure the risk of current network posture. A measurement of risk is valuable to determine the amount of risk reduction achieved by counter measures. Network administrators have an interest in measuring the security risk of running an operating system. When an administrator estimates the security risk, the system administrator adopts multiple measures. One measure is the number of bugs that are found in the operating system in a unit time. This measure is readily available in the vulnerability databases maintained by organizations like CERT and SANS. When an administrator reads a vulnerability advisory, the system administrator is interested in determining whether the bug can be remotely exploited. This information is usually readily available in the bug advisory. A more important question for the administrator is the consequences of the bug.

For a typical system administrator, it is difficult to determine whether the bug results in an administrative account compromise. To determine if a bug can result in an administrative account compromise, the administrator will need to determine the program or library affected by the bug. This task is usually easy, because it is mentioned in the vulnerability advisory. The administrator will then have to determine all the programs that are dependent on this library. If there is a bug in a file (library or program), then any program using the file is vulnerable. In a similar way, a registry key is defined whether register key is vulnerable if the key contains the path to a vulnerable executable. The motivation is that some other program uses this registry key to determine which program to load.

The software environment evolves quickly and it is difficult to determine what programs use what programs or libraries or registry keys. A bug results in a system-wide compromise if the program gets used during the operating system boot or while an administrator logs on to a host. Determining when a program gets used is necessary. It is difficult to determine the conditions under which a program gets used. To determine when a program gets used, the conservative approach of tracing is adopted to determine when a file or registry key gets used.

In Windows, some of the important resources are files and registry keys. Registry and file usage are monitored. One approach would be to modify the kernel by adding a tracing driver. The advantage of this approach is that there is no need for modifying states of registry keys, audit log settings, file and registry access control lists that control auditing on the system. Thus, as opposed to modifying state on the host, which resulted in catastrophic failures of the system, introducing a tracing driver in the kernel is preferred. The fact that access to Windows source code is not available will only make it difficult to pursue this path.

New access control specifications are created for a program that has a dangerous configuration by removing the danagerous access control settings on the program so that it can be installed without the danger of privilege escalation. These dangerous access control settings are readily recognized by computing the privilege escalations and identifying the reason for a particular privilege escalation.

The usermode tracing tools are used to monitor registry and file usage. The regmon utility is used to trace the registry usage. Regmon has the ability to monitor registry accesses in the boot processes, before any user can login. The ‘filemon’ utility was used to monitor the file system accesses, but filemon does not have the ability to monitor the boot processes. The Windows auditing facility is used to determine what user runs what program. Whenever any .exe program is executed, auditing of process execution is turned on. The system writes an entry to the audit log mentioning the path of the program executed and the privilege level of the process. This means that the usage of other types of executable content in Windows like the file types: .cmd, .drv, .msc, .mof, .ocx, .sys, .tsp, .bat, dos, .cpl cannot be traced Another problem is that there is no easy way to turn on auditing of uses of all dynamically-linked library (DLL) files. To audit DLL file accesses, all the DLL files in the file system are located and turn on auditing on each of the files. If the program modified the state on the target system, a bug in the program may leave the operating system in an inconsistent state. Tracing the DLL usage at run time was not considered.

From the output of the regmon, lemon and the system log, who is using the file or registry key is determined. By determining the users of a vulnerable resource, the ultimate privilege level the adversary obtains by leveraging a vulnerability is determined. This experiment on a MicrosoftWindows XP machine was conducted that is not completely patched. The following results were obtained:

| Vulnerable file path | Exploit level |
|---|---|
| C:nProgram Filesn Windows Media Playernwmplayer.exe | User-level |
| C:nProgram Filesn Windows NTnAccessoriesnwordpad.exe | User-level |
| C:nWINDOWSnsystem32ncrypt32.dll | System |
| C:nWINDOWSnsystem32nhlink.dll | System |
| C:nWINDOWSnsystem32ninetcomm.dll | System |
| C:nWINDOWSnSystem32nNtoskrnl.exe | System |
| C:nWINDOWSnsystem32nrpcrt4.dll | System |
| C:nWINDOWSnsystem32nshell32.dll | System |

Thus, given the presence of a bug, a system compromise results in about 66% of the cases. The method disclosed herein, in general, illustrates how to determine the ultimate effects of a reported vulnerability and how to perform risk estimation of a new bug based on historical data.

When vulnerability is reported, the MMVA determines if the security vulnerability reported results in a compromise of the whole system or just certain parts of the system such as a user account or a set of programs. Further the MMVA estimates the risk based on the vulnerability advisory whether the vulnerability will affect the whole computer system or just some parts of the system.

The MMVA determines whether the addition of a particular user to a particular group is safe by performing vulnerability analysis and determining if an escalation from the group to the system node is possible by referring to the pictographic representation of privilege escalations. The MMVA determines that a program should not be installed if the program can lead to a potential privilege escalation.

When a new vulnerability is reported, the MMVA can be used to determine whether a new vulnerability should be notified to the system administrator: if the vulnerability impacts business critical users or files or servers, automatically perform the analysis described above to see if the whole system is under risk, or only certain parts of the system are at risk. If the whole system is under risk, then send a message to the administrator. The MMVA prioritizes the response actions given a large number of security vulnerabilities, for the cyber security manager. The network wide privilege escalations are assigned higher priorities, and localized privilege escalations are assigned lower priorities. This will allow system administrator take actions such as picking the top 5% of bugs to fix, etc.

If it is apriori known that installation of a particular program in a host or hosts in a network adds a particular user to a particular group or makes other known configuration changes to a host or hosts in the network, (Unix, Windows, Solaris machines, etc.) and if the analysis described in this document reveals that from this group one can access critical resources on the network, then special care has to be exercise in installing the program. If the adversary can compromise the user account, he can access critical resources. Or if the program has a known vulnerability that lets the adversary access the critical resources by launching a multi-stage multi-step attack as found by tool disclosed herein, then the installation of the program should be prevented. Thus the tool disclosed herein may be used to identify when a program should not be installed on a host, or group of hosts in a network to preclude potential privilege escalation.

When a bug advisory is released, the vulnerability scanner module can be run to identify the hosts that are affected. Then by running the analysis described in this document, one can identify how each user of the network can access different resources on the network. This analysis can be used to reveal if all parts of the network are affected or only if some parts of the network are affected.

For example, when a vulnerability is reported, an administrator or a vulnerability scanner can identify that certain programs are vulnerable. If some network server programs are using these vulnerable programs, then a principal having the ability to send input to the network vulnerable network programs can take control of the user account of the network program. If further attacks are possible from the compromised user account, like using an access control misconfiguration, or program vulnerability to directly or indirectly compromise the kernel of the host, then the adversary can take control of the elements of this host and launch further attacks. On the other hand, if further attacks are not possible, then the adversary only has limited access to hosts running vulnerable programs.

Since system disclosed herein has the ability to automatically detect if further attacks are possible from each node, the system herein can be used to identify the extent of potential damage before it occurs. An identification can be made whether all the network is compromised, or if only some parts of the network are compromised and to what extent. In particular, if a significant part of the network is likely to compromised, or if resources identified critical by the administrator could be compromised, then the administrator has to be alerted by an appropriate emergency mechanism such as a pager or email.

Suppose that by running the vulnerability scanner and then the analysis described herein, two vulnerabilities A and B are identified that require the administrator to take remediation measures for. Let us suppose that bug A results in complete compromise of the network, while bug B results in a limited compromise for example, where only certain hosts are affected, or certain users of a host are affected. It is clear that responding to bug A is more important than bug B because bug A effects are network-wide.

In the analysis system disclosed herein, the ultimate effects of a bug are identified. The criterion then used is that if vulnerability results in a complete network compromise, then it is more important than a bug that results only in limited compromise. Examples of complete network wide compromise vulnerabilities are remote program vulnerabilies that exist in operating system kernels of all the hosts.

Alternatively, if one is interested in prioritizing remediation measures on a single host level, then remotely-exploitable vulnerabilities that affect the operating system kernel (which result in system-wide compromise and hence administrative account) are more important than bugs that affect a single program running as a non-privileged user.

Thus, the system disclosed herein can be used to identify the transitive consequences of a vulnerability and then classify the risk associated with the vulnerability. If a vulnerability affects more number of resources, that bug is more important than another vulnerability that affects lesser number of resources.

For each reported bug:
Use the system disclosed herein to identify and count the number of user or administrative accounts that are under risk
Rank each vulnerability by the number of administrative or user accounts rendered vulnerable

The bug that has the highest number of accounts under risk should be attended first. Alternatively, if the cyber security managers have resources to attend to only say 5 vulnerabilities, then the security manager should attend to the five bugs with maximum number of accounts under risk.

Thus, in the presence of multiple bugs, the analysis system can be used to prioritize the remediation measures by identifying which vulnerability advisory to be remediated first.

The system disclosed herein can be used to identify the different privilege escalations that are possible in a given state of the network. One can identify whether from a particular user or group, privilege escalations can occur to other parts of the network. The system disclosed herein produces an exhaustive list of privilege escalations of the type: “From A, you can get to B by a series of attacks”. Suppose a particular analysis reveals the following:

A to B

A to D

C to B

After generating the list of all privilege escalation, by making a pass through the list, all the principals whose integrity is important to ensure that B cannot be attacked can be identified. Thus, our system can identify all the users that must be trusted to guarantee the sanctity of a particular host.

In the above example, suppose that C represents a group. Because of operational or other reasons, the administrator might be interested in adding a user E to the group C. If the administrator suspects that E is a potentially malicious user and the administrator is interested in protecting the critical resource B, then adding E to group C is clearly not desirable because it allows the malicious user E to compromise the integrity of critical resource B. Thus, the system disclosed herein can be used to determine if it is safe to add a particular user to a particular group.

Similarly, if installation of a program P opens a path from a compromisable user, or group, or host F to the critical resource B, then installing the program will render the critical resource B compromisable. Thus, the system disclosed herein can be used to identify that installation of program P will open a security hole. This can be used to warn the cyber security manager(s) of ill effects of installing a program before the program is installed on a host or group of hosts.

The MMVA system can be used to identify appropriate remediation measures. In the example shown in FIG. 4, several ways of removing the privilege escalations is shown. For example: the arc from NetworkService to ServerOperator (label grp MBR) can be removed by disabling the user can be done by disabling the user. The arc labeled ServerOperator to System labeled UPNPHOST can be disabled by removing the SERVICE_CHANGE_CONFIG permission for the service UPNPHOST. This is done by supplying CCLCSWLOCRRC as the security descriptor to sc command in SDDL language.

The algorithm for identifying how to remove a privilege escalation is: Privilege escalation due to group membership=>remove the user from the group Priv. esc. due to program misconfiguration (unwanted write)=>remove the write permission
Priv. esc. across hosts=>

Add a firewall rule if it is possible

Or patch the vulnerable program either manually of by using a service such as PatchLink.

Or disconnect/disable the network access.

The analysis system disclosed herein may be supplied in an appropriate format as a software that runs on a host, or a dedicated appliance.

The description above is generic; on a Windows host, the discuss of files and registry keys applies to other sensitive objects WMI providers, Named pipes, processes, network sockets. On a Linux/Solaris/AIX/Unix host, sensitive interactions because of processes, interprocess communication mechanisms, network sockets, etc. need to be considered.

The MMVA system can determine potential privilege escalations in a system or network with multiplicity of hosts. MMVA optionally collects configuration information to determine potential attack targets and mechanisms and other information. MMVA optionally uses the vulnerability scanner to identify how different programs have program vulnerabilities. The vulnerability scanner optionally runs using the configuration data collected by the configuration scanner, thus enabling the vulnerability scanner to run on a host different from the host whose vulnerabilities are being analyzed. A timing module optionally schedules our system to run periodically or when certain important events occur. The network module of MMVA identifies all the programs that accept inputs from the network; these programs are potential targets from an adversary attacking a host from outside the host.

The transitive closure module of MMVA is aware of how different components interact; the behavior of different versions of different operating systems (Red Hat Linux, Debian Linux, Solaris, Windows XP, Windows Vista, etc.) and how attacks propagate on a network. The transitive closure deals also with cases where there may be multiple stage attacks planned by attackers, sometimes in parallel. This module computes all the privilege escalations because of poor configuration, program vulnerabilities and other causes and stores the results in a database. This historical database could be used to see how security of the system or network is evolving over time. In the absence of a security policy, MMVA optionally queries the network manager to determine if certain accesses are allowed and formulate the security policy. The separation of attack simulation and policy compliance it is easy to incorporate new security policies and policy checking algorithms into our system. The transitive closure module emits the privilege escalations to an appropriate pictographic representation program.

MMVA enables a host or network manager to determine the changes of privilege escalations over time and measure the health of the network. The MMVA tool can be used to automatically determine the impact of reported and future vulnerabilities in a network and estimate risk. In case of serious business process disruption, MMVA can be used to automatically alert the infrastrucuture managers through appropriate mechanisms. MMVA can be used to make decisions such as whether to add a particular user to a particular group, whether to install a program, to determine the effects of potential future vulnerabilities, and prioritize disaster management actions and take appropriate remediation measures to address privilege escalation attacks. By determining the root causes of a privilege escalation, MMVA can be used to create new access control specifications for a program. MMVA system can be used to identifying all the users and groups and program that have to be trusted to ensure the security of identified critical resources.

A component of MMVA is a common, interoperable means for abstraction of the security primitives for various operating systems.

It will be readily apparent that the various methods and algorithms described may be implemented in a computer readable medium, e.g., appropriately programmed for general purpose computers and computing devices. Typically a processor, for example, one or more microprocessors will receive instructions from a memory or like device, and execute those instructions, thereby performing one or more processes defined by those instructions. Further, programs that implement such methods and algorithms may be stored and transmitted using a variety of media, for example, computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, central processing unit (CPU) devices, computing devices, microcontrollers, digital signal processors, or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, a carrier wave as described hereinafter, or any other medium from which a computer can read. In general, the computer-readable programs may be implemented in any programming language. Some examples of languages that can be used include c, c++, c#, or java. The software programs may be stored on or in one or more mediums as an object code. A computer program product comprising computer executable instructions embodied in a computer-readable medium comprises computer parsable codes for the implementation of the processes of various embodiments.

Where databases 505 are described, such as the database 505, it will be understood by one of ordinary skill in the art that (i) alternative database 505 structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, for example, tables illustrated in drawings or elsewhere. Similarly, any illustrated entries of the databases represent exemplary information only; one of ordinary skill in the art will understand that the number and content of the entries can be different from the described herein. Further, despite any depiction of the databases 505 as tables, other formats including relational databases 505, object-based models and/or distributed databases 505 could be used to store and manipulate the data types described herein. Likewise, object methods or behaviors of a database 505 can be used to implement various processes, such as the described herein. In addition, the databases 505 may, in a known manner, be stored locally or remotely from a device that accesses data in such a database 505.

The present invention can be configured to work in a network 503 environment including a computer that is in communication, via a communications network 503, with one or more devices. The computer may communicate with the devices directly or indirectly, via a wired or wireless medium such as the Internet 801, local area network (LAN), wide area network (WAN) or ethernet, token ring, or via any appropriate communications means or combination of communications means. Each of the devices may comprise computers, such as those based on the intel®, pentium®, or centrino™ processor, that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. For example, various programming languages and techniques can be used to implement the disclosed invention. Also, the specific logic presented to accomplish tasks within the present invention may be modified without departing from the scope of the invention Those skilled in the art, having the benefit of the teachings of this specification, may effect numerous modifications thereto and changes may be made without departing from the scope and spirit of the invention in its aspects.

We claim:

1. A method of determining potential privilege escalations in a network comprising of one or more hosts, comprising:
performing configuration scanning in a first time period;
conducting vulnerability scanning in said first time period:
determining transitive closure of all security attacks on the network
providing an user interface that renders said potential privilege escalations;
storing a first set of results of said network configuration process in said central server for said first time period;
authenticating said first state of results for said first time period by said security administrator;
performing said network configuration process and said vulnerability analysis for a second time period to generate a second results set further comprising configuration scanning result and second vulnerability scanning result; and
comparing said second set of results with the first set of results and identifying new potential privilege escalations, wherein said new potential privilege escalations potentially compromise security.

2. The method of claim 1, wherein said hosts may run different versions of the same operating system.

3. The method of claim 1, wherein said hosts may run different operating systems.

4. The method of claim 1, wherein said hosts may run different software, inclusive of any of database servers, mail servers.

5. The method of claim 1, wherein said networks containing other networking components such as switches, wireless access points, routers, hubs, and firewalls.

6. The method of claim 1, further comprising providing a storage for the results of said network configuration scanning and said vulnerability scanning for a second time period to generate a second set of results, and further comprising configuration scanning result, second vulnerability scanning result and second user interface output, and comparing said second set of results with the first set of results and identifying new potential privilege escalation attacks that compromise the security of the network.

7. The method of claim 1, wherein said step of performing configuration scanning in a network further comprise the steps of:
making a list of one or multiple of files, services and registry keys, WMI keys, processes, network sockets, interprocess communication channels such as shared memory, named pipes, message queues, semaphores, waitable timers, mailslots, network ports, program services, network shares, and other operating system or hardware resources, and their meta data;
obtaining a list of authorized users who have access to one or more of said files, services and registry keys, WMI keys, processes, network sockets, interprocess communicaton channels such as shared memory, named pipes, message queues, semaphores, waitable timers, mailslots, network ports, operating system and program services;
classifying said authorized users in groups; and
identifying all programs that automatically accept input from the network.

8. The method of claim 1, wherein said first set of results comprises a listing of files, services, registry keys, authorized users, groups and programs, their meta data, and the results of said vulnerability scanning that comprises said vulnerability position of identified programs, potential privilege escalations, and first user interface output.

9. The method of claim 1, wherein a historical database of the results of configuration scanning and vulnerability scanning are stored in the central server.

10. The method of claim 1, wherein when a vulnerability advisory is released, vulnerability scanning is performed.

11. The method of claim 9, a what if analysis is performed to determine adverse actions an adversary entity could pursue after a host is compromised.

12. The method of claim 1, wherein the first set of results and the second set of results comprise program vulnerabilities that are security lapses within said hosts.

13. The method of claim 1, wherein the first set of results and the second set of results comprise configuration vulnerabilities that affect all users and programs of a host.

14. The method of claim 1, wherein vulnerability scanning is performed by using information on the identity of users who are allowed to modify a program, identity of users using the program, the vulnerability advisories that apply to the vulnerability analysis and the formal semantics of said vulnerability advisories.

15. The method of claim 1, wherein said network comprises a plurality of operating systems, a plurality of types of databases and web-server products.

16. The method of claim 1, wherein said vulnerability scanning models network properties that includes vulnerabilities, exploit propagation, user and data binding, user binding, user behavior, host configuration and security policy.

17. The method of claim 1, wherein vulnerability scanning comprises the application of vulnerability rules, further comprising the steps of determining the identity of the vulnerability, the path of a vulnerable program, the identity of the host comprising said vulnerable program, whether the vulnerability can be exploited locally or remotely, consequences of the vulnerability being exploited and capturing transitive dependencies.

18. The method of claim 1, wherein said transitive closure determines all the paths by which an adversary can launch a multi-stage multi-host attack on the network.

19. The method of claim 6, wherein said new potential privilege escalations are remote privilege escalations, wherein a vulnerable program is receptive to messages from a network and the adversary who is not necessarily on the same system as the program but is able to send messages to the program across a network, and further wherein said adversary can exploit said vulnerability to achieve privilege escalation.

20. The method of claim 1, wherein said potential privilege escalations are potential local privilege escalations that occur when a program is vulnerable to an adversary and the vulnerability can be exploited by an adversary who is on the same system as the program.

21. The method of claim 1, wherein in said potential privilege escalation attack, an adversary has the ability to send input to the network server programs identified vulnerable, thereby having access to the user account running the server process.

22. The method of claim 1, wherein an operation system kernel of a host is modeled as both a network service running as root and a local privileged program, and wherein the consequence of exploiting a privilege escalation bug in said operation system kernel will result in a compromise of the system administrative account of the host machine and therefore a compromise of the security of the entire network.

23. The method of claim 1, wherein access control permission to an object in an operating system of a host comprises read, write and execute operations.

24. The method of claim 1, wherein in a network file system, if the adversary can access files residing on the client system of the network file system, then the adversary can access files residing on the file server of the network file system.

25. The method of claim 1, wherein a system administrator specifies permitted activities of principals through a security policy, wherein said security policy specifies the data each principal can access.

26. The method of claim 25, wherein said security policy further comprises binding information specifying principal binding that maps a principal symbol to its user accounts on the hosts.

27. The method of claim 25, wherein said security policy further comprises binding information specifying data binding that assigns a data symbol to a data or hardware resource represented by an access path.

28. The method of claim 1, wherein said step of computing transitive closure comprises attack simulation phase and policy checking phase, wherein in said attack simulation phase, all possible data accesses that can result from multistage, multi-host attacks are derived, and wherein in said policy checking phase, the data output tuples from the attack simulation phase are compared with a given security policy.

29. The method of claim 1, wherein the step of vulnerability scanning further comprises the step of hypothetical analysis, further comprising the steps of representing hypothetical software bugs by logic predicates and determining whether or not said hypothetical software bug can cause the security policy to be violated, and thereafter reporting violations.

30. The method of claim 1, wherein said step of configuration scanning may require the collection of privileged information

31. The method of claim 1, wherein said step of vulnerability scanning further comprises the step of scanning the entire registry and identifying registry keys whose data contain the name or location of an executable file or library, and further analyzing the security descriptor for said identified registry keys to determine if the registry key's content can be overwritten by an entity that does not have the authority to do so.

32. The method of claim 1, further comprising the step of determining if the potential privilege escalation results in a compromise of the whole network or just certain parts of the network such as a user account or a set of programs.

33. The method of claim 10, further comprising the step of estimating the risk based on said potential privilege escalation, and whether potential privilege escalation will affect the whole computer system or just some parts of the system

34. The method of claim 1, further comprising the step of determining whether a new vulnerability impacts business critical users or files or servers, and further determining whether said cyber security managers should be paged or informed about said vulnerability based on said impact of vulnerability.

35. The method of claim 1, further comprising the step of prioritizing the response actions given a large number of security vulnerabilities, wherein network wide privilege escalations are assigned higher priorities, and localized privilege escalations are assigned lower priorities.

36. The method of claim 1, further comprising the step of determining the users and groups that have to be trusted to guarantee the host's integrity, by determining whether the paths from said users or groups to the system exist in the pictographic representation of the privilege escalations.

37. The method of claim 1, further comprising the step of determining whether the addition of a particular user to a particular group is safe by performing said vulnerability analysis and determining if an escalation from said group to the system node is possible.

38. The method of claim 1, further comprising the step of determining multiple vulnerabilities that can be exploited in tandem to get a level of access that is not possible with just a single vulnerability.

39. The method of claim 1, further comprising the step of determining how adversaries can escalate their privileges on a single host, using misconfigurations or vulnerabilities in one or more of files, services and registry keys.

40. The method of claim 1, further comprising the step of determining all the places that an adversary can compromise because of a reported security vulnerability.

41. The method of claim 25, wherein said security policy of a network is determined by the cyber security manager specifying accesses that are permitted and that are not disallowed.

42. The method of claim 1, wherein different network server programs that accept input from the network are considered exploitable over the heterogeneous network if the step of vulnerability scanning reports that said server programs have known bugs.

43. The method of claim 1, wherein transitive dependencies are computed between various users or principals in the network.

44. The method of claim 1, wherein in the absence of a security policy, a raw trace of which user can access what program or resource of the heterogeneous network is provided.

45. The method of claim 1, wherein the data binding information of the network is determined by querying files and servers in the network.

46. The method of claim 1, wherein the step of configuration collection if performed before vulnerability is reported, determines that the configuration data collected is trustworthy.

47. The method of claim 1, further comprising the step of determining that a program should not be installed if said program can lead to a potential privilege escalation.

48. The method of claim 1, further comprising the step of creating new access control specifications for a program that has a dangerous configuration, whereby said program can be installed without the danger of privilege escalations.

49. A method of determining potential privilege escalations in a network comprising of one or more hosts, comprising the steps of:
performing configuration scanning:
conducting vulnerability scanning;
determining transitive closure of all privilege escalations on said network;
providing a user interface output that renders said privilege escalations; and,
presenting said user interface output to said cyber security managers.

50. A system for determining potential privilege escalations in a network comprising a plurality of hosts and operating systems managed by one or more administrators, further comprising:
a configuration scanning module for performing a configuration scan on said network at predetermined time periods;
a vulnerability scanning module for conducting a vulnerability scan on the result of said configuration scan at said predetermined time periods;
a timing module for scheduling the predetermined time periods;
a database for storing the configuration scan results of the configuration scanning module and the vulnerability scan results of the vulnerability scanning module;
a user interface module to present the results in a suitable interface to one or more administrators and help understand the results;
a state differential module for comparing the states of two subsequent configuration scans of the configuration scanning module and the vulnerability scan module;
said administrator providing administrative privileges for the configuration scanning module and providing a security policy, wherein said security policy specifies the data each principal can access; and,
a graphical user interface for rendering potential privilege escalations derived from the configuration scan results and vulnerability scan results.

51. The system of claim 50, wherein said configuration scan module runs with or without said administrative privileges.

52. The system of claim 50, wherein the configuration scanning module and the vulnerability scanning module may run on the same or separate computing platforms, and wherein the vulnerability scanning module does not require to be a part of the trusted computing base.

53. The system of claim 50, wherein said vulnerability scanning module determines network configuration vulnerabilities as well as single host configuration vulnerabilities.

54. A computer program product comprising computer executable instructions embodied in a computer-readable medium, in a network of hosts comprising a server and a plurality of hosts in the domain of an administrator, said computer program product including:
a first computer parsable program code for performing a configuration scan on said network at predetermined time periods;
a second computer parsable program code for conducting a vulnerability scan on the result of said configuration scan at said predetermined time periods;
a third computer parsable program code for scheduling the predetermined time periods;
a fourth computer parsable program code for storing the configuration scan results and the vulnerability scan results;
a fifth computer parsable program code for comparing the states of two subsequent configuration scans and the vulnerability scans; and
a sixth computer parsable program code for rendering potential privilege escalations derived from the configuration scan results and vulnerability scan results.
